(19) United States
(12) Patent Application Publication
(10) Pub. No.: US 2026/0329441 A1
(43) Pub. Date: Oct. 22, 2026

(54) PERFORMANT ORDERING MECHANISM FOR IO IN BLOCK ALLOCATOR FOR WRITING TO DRIVE

(71) Applicant: Samsung Electronics Co., Ltd., Suwon-si (KR)

(72) Inventors: Ramachaitanya KAVULURU, Santa Clara, CA (US); Somnath ROY, San Ramon (KR); Benixon ARUL DHAS, Gilroy, CA (US); Harsh ROOGI, Pleasanton, CA (US); Danlin JIA, Santa Clara, CA (US)

(21) Appl. No.: 19/181,322

(22) Filed: Apr. 16, 2025

(51) Int. Cl. G06F 12/02

(52) U.S. Cl. CPC G06F 3/0613; G06F 3/0659; G06F 3/0679

(57) ABSTRACT

A system is disclosed. The system may include a queue to store a request, the request including a first address. A data structure may store information associated with a second address. A submission component may send the request to a storage device based at least in part on an overlap between the first address and the second address associated with the information in the data structure.

### RELATED APPLICATION DATA

This application is related to U.S. patent application Ser. No. ______, filed ______, and to U.S. patent application Ser. No. 18/830,559, filed Sep. 10, 2024, which claims the benefit of U.S. Provisional Patent Application Ser. No. 63/635,257, filed Apr. 17, 2024, all of which are incorporated by reference herein for all purposes.

### FIELD

The disclosure relates generally to storage, and more particularly to maintaining consistency within storage devices.

### BACKGROUND

Applications may issue requests to read and write data to storage devices. But these requests might be delivered to the storage device in an order different from the order in which the requests were issued. As a result, the data on the storage device might not be consistent with the expectations of the application.

A need remains to maintain the consistency of storage devices.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 shows a machine equipped to manage input/output (I/O) requests to a storage device, according to embodiments of the disclosure.

FIG. 2 shows details of the machine of FIG. 1, according to embodiments of the disclosure.

FIG. 3 shows details of the storage device of FIG. 1, according to embodiments of the disclosure.

FIG. 4 shows how I/O requests in the machine of FIG. 1 may overlap, according to embodiments of the disclosure.

FIG. 5 shows details of the request submission component of FIG. 1, according to embodiments of the disclosure.

FIG. 6 shows how the queue of FIG. 5 and the radix tree of FIG. 5 may be used to manage submitting requests to the storage device of FIG. 1, according to embodiments of the disclosure.

FIG. 7 shows details of the logical block index manager of FIG. 1, according to embodiments of the disclosure.

FIG. 8 shows details of the bitmap of FIG. 7 and the mapping table of FIG. 7, according to embodiments of the disclosure.

FIG. 9A shows details of a block used to store a value in the storage device of FIG. 1, according to embodiments of the disclosure.

FIG. 9B shows details of a block used to store a key in the storage device of FIG. 1, according to embodiments of the disclosure.

FIG. 9C shows details of a block used to store a key collision in the storage device of FIG. 1, according to embodiments of the disclosure.

FIG. 9D shows details of a block used to store a key collision extension in the storage device of FIG. 1, according to embodiments of the disclosure.

FIG. 9E shows details of a block used to store a data collision metadata in the storage device of FIG. 1, according to embodiments of the disclosure.

FIG. 10 shows a state transition diagram for the states of blocks being written to the storage device of FIG. 1, according to embodiments of the disclosure.

FIG. 11 shows a state transition diagram for the states of blocks being deleted from the storage device of FIG. 1, according to embodiments of the disclosure.

FIG. 12 shows a flowchart of an example procedure for the submission component of FIG. 5 to process I/O requests, according to embodiments of the disclosure.

FIG. 13 shows a flowchart of an example procedure for the request submission component of FIG. 1 to determine whether to send an I/O request to the storage device of FIG. 1 or to delay sending it, according to embodiments of the disclosure.

FIG. 14 shows a flowchart of an example procedure for the request submission component of FIG. 1 to coalesce two I/O requests, according to embodiments of the disclosure.

FIG. 15 shows a flowchart of an example procedure for the request submission component of FIG. 1 to handle a completion message from the storage device of FIG. 1, according to embodiments of the disclosure.

FIG. 16 shows a flowchart of an example procedure for the logical block index manager of FIG. 1 to process an I/O request, according to embodiments of the disclosure.

FIG. 17 shows a flowchart of an example procedure for additional processing by the logical block index manager of FIG. 1, according to embodiments of the disclosure.

FIG. 18A shows a flowchart of an example procedure for the logical block index manager of FIG. 1 to set the state of blocks in the storage device of FIG. 1, according to embodiments of the disclosure.

FIG. 18B continues the flowchart of FIG. 18A of an example procedure for the logical block index manager of FIG. 1 to set the state of blocks in the storage device of FIG. 1, according to embodiments of the disclosure.

FIG. 18C continues the flowchart of FIGS. 18A-18B of an example procedure for the logical block index manager of FIG. 1 to set the state of blocks in the storage device of FIG. 1, according to embodiments of the disclosure.

FIG. 19 shows a flowchart of an example procedure for the logical block index manager of FIG. 1 to update blocks based on an I/O request, according to embodiments of the disclosure.

FIG. 20 shows a flowchart of an example procedure for additional processing by the logical block index manager of FIG. 1, according to embodiments of the disclosure.

FIG. 21A shows a flowchart of an example procedure for the logical block index manager of FIG. 1 to set the state of blocks in the storage device of FIG. 1, according to embodiments of the disclosure.

FIG. 21B continues the flowchart of FIG. 21A of an example procedure for the logical block index manager of FIG. 1 to set the state of blocks in the storage device of FIG. 1, according to embodiments of the disclosure.

FIG. 21C continues the flowchart of FIGS. 21A-21B of an example procedure for the logical block index manager of FIG. 1 to set the state of blocks in the storage device of FIG. 1, according to embodiments of the disclosure.

FIG. 22 shows a flowchart of an example procedure for rebuilding the bitmap of FIG. 7 from the storage device of FIG. 1, according to embodiments of the disclosure.

FIG. 23 shows a flowchart of an example procedure for prefetching of blocks from the storage device of FIG. 1, according to embodiments of the disclosure.

### SUMMARY

A submission system may store input/output (I/O) requests in a queue. Before removing a request from the queue, the system may determine whether the request conflicts with any in-flight requests. If there is any conflict with an in-flight request, the request may be delayed until the in-flight request completes.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Applications may issue requests to access storage devices. For example, an application might issue requests to read data from storage devices, or to write data to storage devices.

But in some situations, it might happen that the requests as issued by the application might be processed by the storage device in a different order. As a result, the data as stored on the storage device might be inconsistent with the expectations of the application, and with memory maps that might exist in the main memory of the computer system.

For example, consider the situation where an application writes data to (logical) addresses 0x0100 through 0x0107, and subsequently writes data to (logical) addresses 0x0105 through 0x010A. For (logical) addresses 0x0100 through 0x0104 and 0x0108 through 0x010A, the order in which these operations are performed does not matter. But for (logical) addresses 0x0105 through 0x0107, the order in which these write requests are processed may matter. For example, if the second write request is processed first, and the first write request is processed second, then the data in (logical) addresses 0x0105 through 0x0107 is now out-of-date. Subsequent read operations may then return the old, out-of-date data.

Note that this problem is not limited simply to write requests. Consider the situation where an application writes data to (logical) addresses 0x0100 through 0x0107, and subsequently reads data from (logical) address 0x0106. If the read request is processed before the write request, the read request will return old, out-of-date data, since the application will be expecting the data that was just written by the preceding write request.

Another problem associated with handling transactions at a storage device, particularly write requests, is that the host memory may include a bitmap that reflects the state of the data on the storage device. This bitmap may reflect what blocks currently store data, and what type of data they store, and what blocks are free. Maintaining this information may expedite transactions using the storage device. But because main memory is often volatile storage, if there is a power interruption or the computer is shut down for some reason, it may be important to rebuild this bitmap from data stored on the storage device (which is often non-volatile storage).

Embodiments of the disclosure address this problem by establishing a data structure that tracks what requests involve what data on the storage device. If the request at the head of the queue does not conflict with another request already being processed, then the request is sent to the storage device, with the relevant information added to the data structure. Otherwise, the request is delayed to permit the conflicting request to complete (subsequent requests pending in the queue may also be delayed). Once the conflicting request is completed, the request at the head of the queue may then be sent to the storage device, again with relevant information added to the data structure.

Request completion may involve updating the data structure to reflect that the request is complete, thereby permitting any conflicting request to be executed.

Embodiments of the disclosure may also improve efficiency by dividing the storage device into regions, with each region being handled by a separate data structure. This may provide a benefit, for example, where requests affecting different regions of the storage device may be executed in parallel, even as requests associated with one region might be delayed due to a conflict.

Embodiments of the disclosure may also support coalescing multiple request that conflict into fewer requests. For example, consider again the situation where two write requests update data spanning (logical) addresses 0x0100 through 0x010A. Since (logical) addresses 0x0105 through 0x0107 are being written to twice, only the second write request may be performed for those (logical) addresses, as the first write request would be immediately rendered redundant: the two write requests, at least for these (logical) addresses, may be coalesced into a single transaction.

Embodiments of the disclosure may support managing the bitmap in main memory. This bitmap may track what blocks on the storage device are free and what blocks are in use. The blocks themselves may store information about how the data is organized on the storage device. For example, blocks may include both meta blocks (information about where and how data is stored) and data blocks (which store data).

The storage device itself may be a block storage device, even though applications may issue key value storage requests. To store the data, embodiments of the disclosure may use a hash function to map the key to a block number, where the block number is in a range of block numbers supported by the storage device. In addition, a range of blocks sufficient to store the data may be allocated. If the block represented by the block number is currently free, the block may be filled with metadata, such as pointers to one or more of the blocks where the data is actually stored, and the data may be stored in those blocks. The bitmap may then be updated to reflect that blocks have been allocated.

If the block number generated by the hash function is already in use, that block may be a meta block or a value block. If the block is a meta block, the meta block may be updated to reflect the hash collision, and may point to both the original data identified by that block or to a new meta block for the data being written as part of the new write request (this second pointer may be a direct pointer or an indirect pointer, in the situation where there is insufficient space in the meta block for a pointer based on an additional collision). If the block is a data block, the data block may be identified as being part of a collision, and a mapping table in the memory may map from the address of that block to an address of a free block that is now used to store the metadata for the new write request. Thus, blocks may be identified as one of the following types: key block; key collision block; collision extension block; data collision meta block; value block; or data collision block.

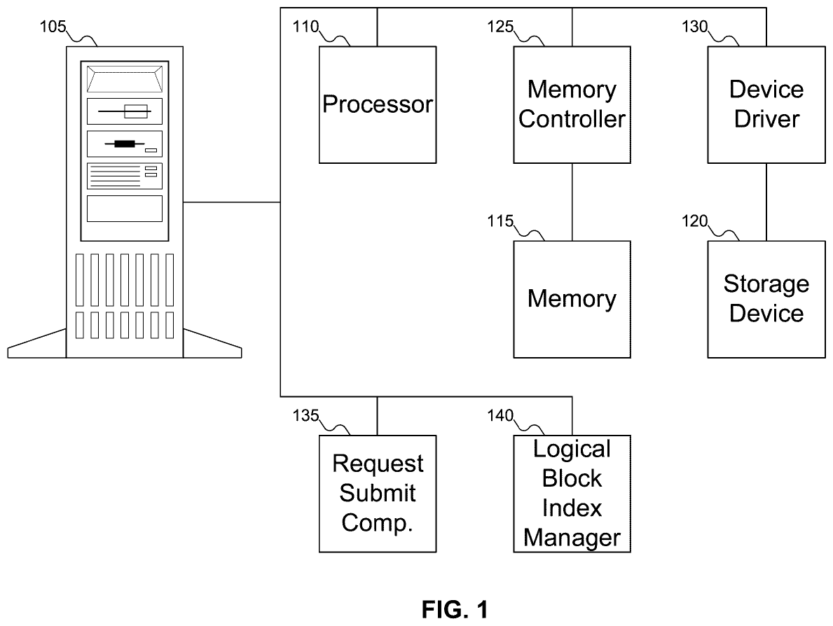

FIG. 1 shows a machine equipped to manage input/output (I/O) requests to a storage device, according to embodiments of the disclosure. In FIG. 1, machine 105, which may also be termed a host or a system, may include processor 110, memory 115, and storage device 120. While FIG. 1 shows one storage device 120, embodiments of the disclosure may include any number of storage devices 120.

Processor 110, which may also be referred to as a host processor, may be any variety of processor. (Processor 110, along with the other components discussed below, are shown outside the machine for ease of illustration: embodiments of the disclosure may include these components within the machine.) While FIG. 1 shows a single processor 110, machine 105 may include any number (one or more, without bound) of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115, which may also be referred to as a main memory, may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage device 120. Whereas memory 115 may be used to store data that is considered “short-term”, storage device 120 may be used to store data that is considered “long-term”: that is, data that is expected to be retained for longer periods of time and that should be retained in a persistent manner, even if delivery of power to machine 105 should be interrupted. Storage device 120 may be accessed using device driver 130. While FIG. 1 shows one device driver 130 being used to manage access to storage device 120, embodiments of the disclosure may include more than one device driver 130, each used to manage access to different storage devices 120, or a single device driver 130 may be used to manage access to all storage devices 120.

Storage device 120 may be associated with an accelerator. Such an accelerator may be used for, for example, near-data processing. That is, the accelerator may be used to process data closer to storage device 120, to reduce or eliminate transfer of data from storage device 120 into memory 115. The use of an accelerator for near-data processing may also offload processing from processor 110, as the accelerator may perform such processing instead of processor 110.

Like processor 105, such an accelerator may implement a Reduced Instruction Set Computer (RISC) architecture or a Complex Instruction Set Computer (CISC) architecture (among other possibilities), and may be implemented, for example, using a Central Processing Unit (CPU), a Field Programmable Gate Array (FPGA), an Application-Specific Integrated Circuit (ASIC), A System-on-a-Chip (SoC), a Graphics Processing Unit (GPU), a General Purpose GPU (GPGPU), a Neural Processing Unit (NPU), or a Tensor Processing Unit (TPU).

The combination of storage device 120 and accelerator may also be referred to as a computational storage device, computational storage unit, computational storage device, or computational device. Storage device 120 and an accelerator may be designed and manufactured as a single integrated unit, or the accelerator may be separate from storage device 120. The phrase “associated with” is intended to cover both a single integrated unit including both a storage device and an accelerator and a storage device that is paired with an accelerator but that are not manufactured as a single integrated unit. In other words, a storage device and an accelerator may be said to be “paired” when they are physically separate devices but are connected in a manner that enables them to communicate with each other. Further, in the remainder of this document, any reference to storage device 120 may be understood to refer to both storage device 120 and the accelerator either as physically separate but paired (and therefore may include the other device) or to both devices integrated into a single component as a computational storage unit.

In addition, the connection between the storage device and the paired accelerator might enable the two devices to communicate, but might not enable one (or both) devices to work with a different partner: that is, the storage device might not be able to communicate with another accelerator, and/or the accelerator might not be able to communicate with another storage device. For example, the storage device and the paired accelerator might be connected serially (in either order) to the fabric, enabling the accelerator to access information from the storage device in a manner another accelerator might not be able to achieve.

While FIG. 1 uses the generic term “storage device”, embodiments of the disclosure may include any storage device formats that may be associated with computational storage, examples of which may include hard disk drives and Solid State Drives (SSDs). In addition, in systems that include multiple storage devices 120, storage devices 120 may be of the same or different types. For example, one storage device 120 might be an SSD, whereas another storage device 120 might be a hard disk drive. Any reference to a specific type of storage device, such as an “SSD”, below should be understood to include such other embodiments of the disclosure.

Processor 105 and storage device 120 may communicate across a fabric (not shown in FIG. 1). This fabric may be any fabric along which information may be passed. Such fabrics may include fabrics that may be internal to machine 105, and which may use interfaces such as Peripheral Component Interconnect Express (PCIe), Serial AT Attachment (SATA), or Small Computer Systems Interface (SCSI), among others. Such fabrics may also include fabrics that may be external to machine 105, and which may use interfaces such as Ethernet, Infiniband, or Fibre Channel, among others. In addition, such fabrics may support one or more protocols, such as Non-Volatile Memory Express (NVMe), NVMe over Fabrics (NVMe-oF), Simple Service Discovery Protocol (SSDP), or a cache-coherent interconnect protocol, such as the Compute Express Link ® (CXL®) protocol, among others. (Compute Express Link and CXL are registered trademarks of the Compute Express Link Consortium in the United States.) Thus, such fabrics may be thought of as encompassing both internal and external networking connections, over which commands may be sent, either directly or indirectly, to storage device 120. In embodiments of the disclosure where such fabrics support external networking connections, storage device 120 might be located external to machine 105, and storage device 120 might receive requests from a processor remote from machine 105.

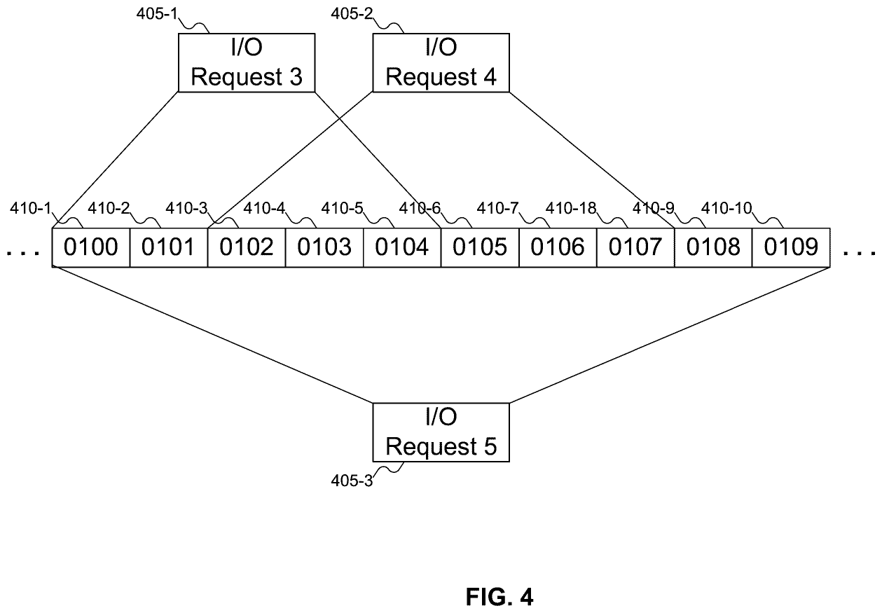

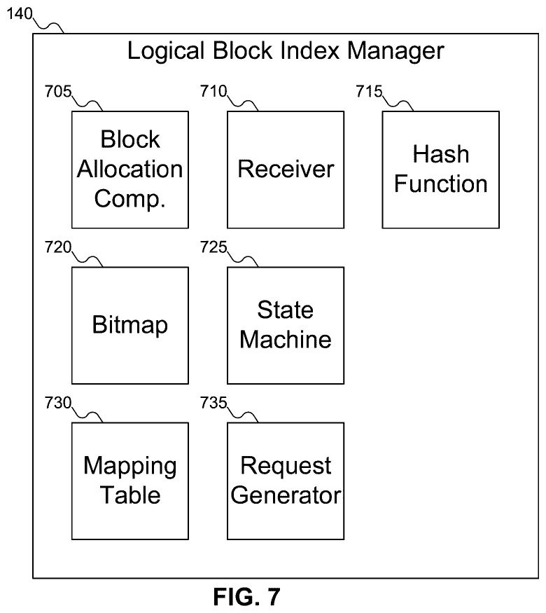

Machine 105 may also include request submission component 135 and logical block index manager 140. Request submission component 135 may manage sending requests to storage device 120 to attempt to keep requests in order and avoid problems with how data is updated on storage device 120. Logical block index manager 140 may manage the selection of blocks on storage device 120 to satisfy particular access requests being sent to storage device 120. Request submission component 135 is discussed further with reference to FIGS. 4-6 and 12-15; logical block index manager is discussed further with reference to FIGS. 7-11 and 16-23 below.

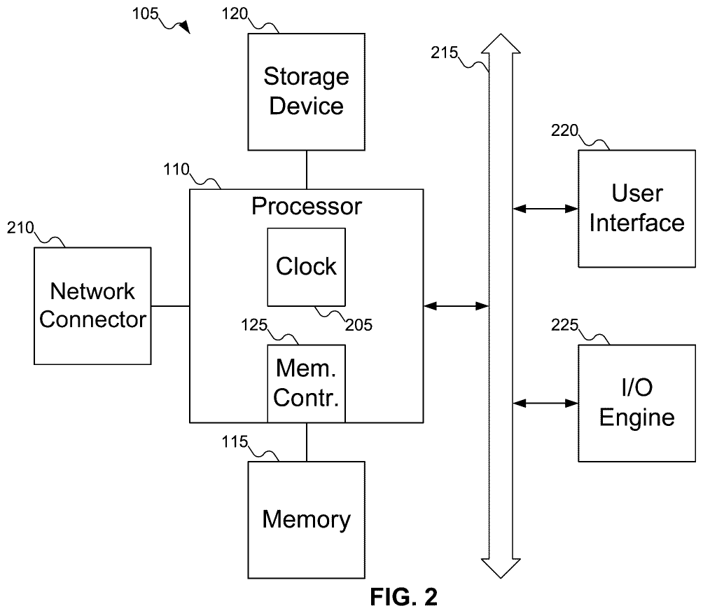

FIG. 2 shows details of the machine of FIG. 1, according to embodiments of the disclosure. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage device 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components.

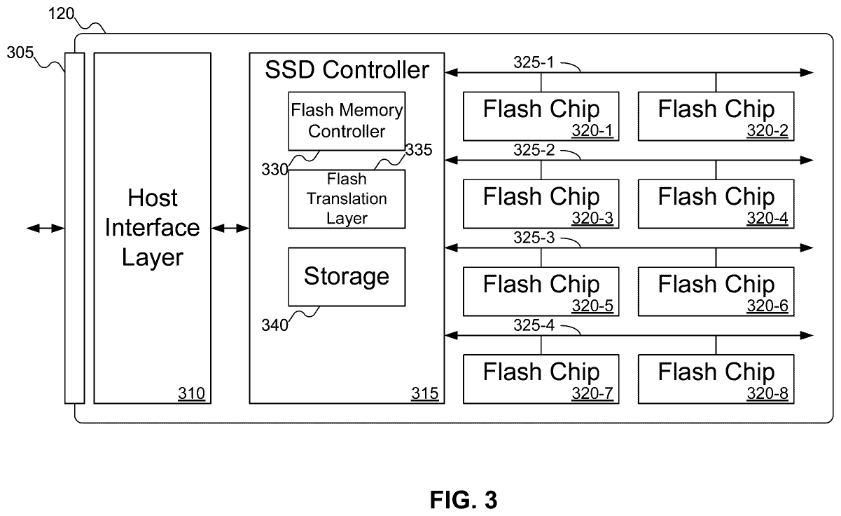

FIG. 3 shows details of storage device 120 of FIG. 1, according to embodiments of the disclosure. In FIG. 3, storage device 120 is shown using an implementation including SSD 120, but embodiments of the disclosure are applicable to any type of storage device that may support caching of data, as discussed below.

SSD 120 may include interface 305 and host interface layer 310. Interface 305 may be an interface used to connect SSD 120 to machine 105 of FIG. 1. Examples of such interfaces may include Serial AT Attachment (SATA), mSATA, Serial Attached Small Computer Systems Interface (SCSI) (SAS), NVMe, PCIe, U.2, M.2, and Enterprise and Datacenter Standard Form Factor (EDSFF); other interfaces are also possible. SSD 120 may include more than one interface 305: for example, one interface might be used for block-based read and write requests, and another interface might be used for key-value read and write requests. While FIG. 3 suggests that interface 305 is a physical connection between SSD 120 and machine 105 of FIG. 1, interface 305 may also represent protocol differences that may be used across a common physical interface. For example, SSD 120 might be connected to machine 105 using a U.2, EDSFF, or an M.2 connector, among other possibilities, and SSD 120 may support block-based requests and key-value requests: handling the different types of requests may be performed by a different interface 305. SSD 120 may also include a single interface 305 that may include multiple ports, each of which may be treated as a separate interface 305, or just a single interface 305 with a single port, and leave the interpretation of the information received over interface 305 to another element, such as SSD controller 315.

Host interface layer 310 may manage interface 305, providing an interface between SSD controller 315 and the external connections to SSD 120. If SSD 120 includes more than one interface 305, a single host interface layer 310 may manage all interfaces, SSD 120 may include a host interface layer 310 for each interface, or some combination thereof may be used.

SSD 120 may also include SSD controller 315 and various flash memory chips 320-1 through 320-8, which may be organized along channels 325-1 through 325-4. Flash memory chips 320-1 through 320-8 may be referred to collectively as flash memory chips 320, and may also be referred to as flash chips, memory chips, NAND chips, chips, or dies. Channels 325-1 through 325-4 may be referred to collectively as channels 325.

SSD controller 315 may manage sending read requests and write requests to flash memory chips 320 along channels 325. SSD 120 may retrieve such requests from a submission queue located in, for example, memory 115 of FIG. 1. For example, as new requests are placed in a submission queue, a doorbell may be rung in SSD controller 315 to alert SSD 120 that there are new requests pending. Controller 315 may also include flash memory controller 330, which may be responsible for issuing commands to flash memory chips 320 along channels 325. Flash memory controller 330 may also be referred to more generally as memory controller 330 in embodiments of the disclosure where storage device 120 stores data using a technology other than flash memory chips 320. Although FIG. 3 shows eight flash memory chips 320, four channels 325, and one flash memory controller 330, embodiments of the disclosure may include any number (one or more, without bound) of channels 325 including any number (one or more, without bound) of flash memory chips 320, and any number (one or more, without bound) of flash memory controllers 330.

Within each flash memory chip or die, the space may be organized into planes. These planes may include multiple erase blocks (which may also be referred to as blocks), which may be further subdivided into wordlines. The wordlines may include one or more pages. For example, a wordline for Triple Level Cell (TLC) flash media might include three pages, whereas a wordline for Multi-Level Cell (MLC) flash media might include two pages. In some embodiments of the disclosure, the page may be the smallest unit of data that may be written to or read from SSD 120; in other embodiments of the disclosure, the smallest unit of data that may be written to or read from SSD 120 may differ from the size of a page.

Erase blocks may also be logically grouped together by controller 315, which may be referred to as a superblock. This logical grouping may enable controller 315 to manage the group as one, rather than managing each block separately. For example, a superblock might include one or more erase blocks from each plane from each die in SSD 120. So, for example, if SSD 120 includes eight channels, two dies per channel, and four planes per die, a superblock might include 8×2×4=64 erase blocks.

SSD controller 315 may also include flash translation layer (FTL) 335 (which may be termed more generally a translation layer, for storage devices that do not use flash storage). FTL 335 may handle translation of logical block addresses (LBAs) or other logical IDs (as used by processor 110 of FIG. 1) and physical block addresses (PBAs) or other physical addresses where data is stored in flash chips 320. FTL 335, may also be responsible for tracking data as it is relocated from one PBA to another, as may occur when performing garbage collection and/or wear leveling.

SSD controller 315 may also include storage 340. Storage 340 may be used, for example, as a staging point for data being moved into or out of flash chips 320. For example, storage 340 may be used to store data to be written to flash chips 320, or data being read from flash chips 320. Storage 340 may take any desired form, including volatile or non-volatile storage forms, such as DRAM or other forms of memory and/or storage. In some embodiments of the disclosure, part or all of storage 340 may be accessible to applications or other tools, such as request submission component 135 of FIG. 1 or logical block index manager 140 of FIG. 1, on machine 105 of FIG. 1, or SSD 120 may include multiple versions of storage 340, which may individually be accessible to applications or other components of machine 105 of FIG. 1. For example, SSD 120 might be a CXL SSD, with storage 340 accessible to request submission component 135 of FIG. 1 or logical block index manager 140 of FIG. 1 to expedite communication between machine 105 of FIG. 1 and SSD 120.

While FIG. 3 shows SSD controller 315 as including flash memory controller 330, flash translation layer 335, and storage 340, embodiments of the disclosure may have any, some, or all of these elements located outside SSD controller 315, without loss of generality.

FIG. 4 shows how I/O requests in machine 105 of FIG. 1 may overlap, according to embodiments of the disclosure. In FIG. 4, three I/O requests 405-1, 405-2, and 405-3 are shown (I/O requests 405-1, 405-2, and 405-3 may be referred to collectively as I/O requests 405 or just as requests 405). For purposes of this discussion, it may be assumed that I/O request 405-1 is the first I/O request issued by an application and received at request submission component 135 of FIG. 1, I/O request 405-2 is the second I/O request issued by an application and received at request submission component 135 of FIG. 1, and I/O request 405-3 is the third I/O request issued by an application and received at request submission component 135 of FIG. 1 (I/O requests 405-1, 405-2, and 405-3 might all be issued by the same application, or might be issued by different applications). Each I/O request 405 may involve accessing one or more logical addresses in storage device 120 of FIG. 1. For example, consider the address space exposed by storage device 120 of FIG. 1 as a sequence of addresses: FIG. 4 shows a subset of this address range, spanning addresses 410-1 through 410-10 (which may be referred to collectively as addresses 410). I/O request 405-1 is shown as accessing addresses 410-1 through 410-5, I/O request 405-2 is shown as accessing addresses 410-3 through 410-8, and I/O request 405-3 is shown as accessing addresses 410-1 through 410-10 (which may be referred to collectively as addresses 410). While FIG. 4 shows 10 addresses 410, embodiments of the disclosure may include any number of addresses 405. Storage device 120 of FIG. 1 may have its own optimal write boundaries: for example, an SSD might optimally write 128 kilobytes (KB) of data at a time, and writing less or more than this amount may lead to inefficiencies.

If I/O requests 405 were all read requests, there would be little problem, as read requests do not change the data being read. But if any of I/O requests 405 are write requests, potential problems may arise. For example, consider the situation where I/O request 405-1 is a read request, but I/O request 405-2 is a write request. If these requests are processed out of order, or even in parallel, it is possible that the data in addresses 410-3, 410-4, and 410-5 might be updated by I/O request 405-2 before they are read by I/O request 405-1. Since I/O request 405-1 was issued before I/O request 405-2, this situation would mean that the wrong data was returned from storage device 120 of FIG. 1 in response to I/O request 405-1.

The same problem may also occur if I/O request 405-1 is a write request, and I/O request 405-2 is a read request. If the data is read from addresses 410-3, 410-4, and 410-5 in response to I/O request 405-2 before the data in those addresses are updated by I/O request 405-1, then stale data might be returned in response to I/O request 405-2.

If both I/O requests 405-1 and 405-2 are write requests, then the order of processing may also matter. Since I/O request 405-2 was issued later, the data to be written into addresses 410-3, 410-4, and 410-5 by I/O request 405-2 are what should be stored after both I/O requests complete. But if both I/O requests 405-1 and 405-2 are processed at the same time, or are processed out of order, then the data in addresses 410-3, 410-4, and/or 410-5 might be incorrect (if any of those addresses were updated by I/O request 405-2 first, then updated afterward by I/O request 405-1).

Thus, given these possible situations, it is important to ensure that requests are processed by storage device 120 of FIG. 1 in the order issued by the application, so that the correct data is stored after all the requests are completed.

There are also other possible optimizations that may be useful. For example, consider the situation where I/O requests 405-1, 405-2, and 405-3 are all write requests. Since I/O request 405-3 overwrites all the data written by I/O requests 405-1 and 405-2, it is possible to coalesce all three requests into one: just to complete write request 405-3. On the other hand, consider the situation where I/O requests 405-1 and 405-3 are write requests, but I/O 405-2 is a read request. Since there is a request to read data from some of addresses 405-1 through 405-10 in between I/O request 405-1 and 405-3, it may not be possible to coalesce I/O requests 405-1 and 405-3: doing so might result in the wrong data being returned for I/O request 405-2.

But now consider the situation where I/O requests 405-1 and 405-2 are write requests, and I/O request 405-3 is a read request. Since both I/O requests 405-1 and 405-2 write to addresses 410-3, 410-4, and 410-5, ultimately only the data written to those addresses by I/O request 405-2 matters. But since I/O request 405-2 does not overwrite everything written by I/O request 405-1, I/O request 405-1 may not simply be discarded. Instead, the addresses 410 that are written by both I/O requests 405-1 and 405-2 may be identified, and then written only by I/O request 405-2: the data written to those addresses 410 by I/O request 405-1 may be disregarded.

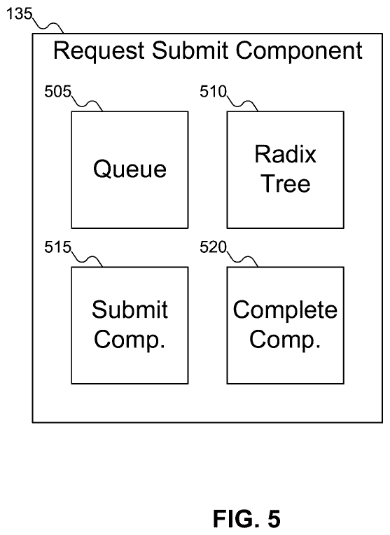

FIG. 5 shows details of request submission component 135 of FIG. 1, according to embodiments of the disclosure. In FIG. 5, request submission component 135 may include queue 505, radix tree 510, submission component 515, and completion component 520. Queue 505 may be a queue into which requests 405 of FIG. 4 may be placed for ultimate submission to storage device 120. (As discussed further below, in some embodiments of the disclosure, requests 405 of FIG. 4 may be placed in queue 505 by logical block index manager 140 of FIG. 1 or by the system of U.S. patent application Ser. No. 18/830,559, filed Sep. 10, 2024, which claims the benefit of U.S. Provisional Patent Application Ser. No. 63/635,257, filed Apr. 17, 2024, both of which are incorporated by reference herein for all purposes, among other possibilities.) Radix tree 510 may be a data structure used to track which addresses 410 of FIG. 4 in storage device 120 of FIG. 1 are affected by requests currently in-flight to storage device 120 of FIG. 1 (in this context, “in-flight” should be understood to mean that an I/O request 405 of FIG. 4 has been forwarded to storage device 120 of FIG. 1, although storage device 120 of FIG. 1 might not yet be processing that I/O request). If there is a conflict (or potential conflict) between addresses 410 of FIG. 4 in radix tree 510 and addresses 410 of FIG. 4 in a request 405 of FIG. 4 currently in queue 505, that request 405 of FIG. 4 may be delayed until the conflict is resolved. For purposes of this disclosure, a “conflict” may exist if an address in I/O request 405 of FIG. 4 is also an address accessed in another I/O request 405 of FIG. 4 that is already in-flight at storage device 120 of FIG. 1. (Request 405 of FIG. 4 is said to be in-flight if request 405 of FIG. 4 has been dispatched to storage device 120 of FIG. 1—for example, placed in a submission queue with a doorbell rung at storage device 120 of FIG. 1—but request submission component 135 has not yet processed an acknowledgement from storage device 120 of FIG. 1 that the pending request 405 of FIG. 4 has been completed.) Another way to think of this “conflict” is that the address in I/O request 405 of FIG. 4 overlaps an address in another I/O request 405 of FIG. 4 that is already in-flight at storage device 120 of FIG. 1. It is possible to think of radix tree 510 as locking addresses 410 currently being accessed in requests in-flight to storage device 120 of FIG. 1: when those requests are complete, the addresses 410 associated with those requests may be unlocked so that they may be used in later requests 405 of FIG. 4.

While FIG. 5 refers to the data structure as a radix tree, which has potential benefits for performing insertion and deletion operations as the data structure is to be updated, embodiments of the disclosure may also use any desired data structure other than a radix tree: any reference to a radix tree may be understood as also referencing any desired alternative data structure. In some embodiments of the disclosure queue 505 and radix tree 510 may be managed in memory 115 of FIG. 1; in other embodiments of the disclosure, queue 505 and/or radix tree 510 may be stored in locations other than memory 115 of FIG. 1, and may be stored in different locations.

For example, request submission component 135 might include its own memory to store queue 505 and/or radix tree 510.

Submission component 515 may include instructions for how to manage removing requests 405 of FIG. 4 from queue 505 and sending those requests 405 of FIG. 4 to storage device 120 of FIG. 1: for example, by placing such requests in a submission queue in memory 115 of FIG. 1 and ringing a doorbell in SSD controller 315 of FIG. 3. Completion component 520 may include instructions for how to manage receiving completion messages from storage device 120 of FIG. 1 indicating that a particular request 405 of FIG. 4 (as identified by the completion message) has been fully processed, and therefore may be considered completed rather than in-flight. Submission component 515 and completion component 520 may take any desired form. For example, submission component 515 and completion component 520 may be memory modules (such as Read-Only Memory (ROM) memory modules) that store instructions, which may be firmware, to be executed on processor 110 of FIG. 1 or a processor within request submission component 135. Or, submission component 515 and completion component 520 may be implemented using a Central Processing Unit (CPU), a Field Programmable Gate Array (FPGA), an Application-Specific Integrated Circuit (ASIC), a System-on-a-Chip (SoC), a Graphics Processing Unit (GPU), a General Purpose GPU (GPGPU), a Neural Processing Unit (NPU), or a Tensor Processing Unit (TPU), among other possibilities. Submission component 515 and completion component 520 may also be implemented using different approaches. Submission component 515 and completion component 520 may also be implemented as separate threads executing on a single processor, such as processor 110 of FIG. 1. Whatever implementation(s) is/are chosen for submission component 515 and completion component 520, the implementation may include all the necessary components, specifically the hardware (and possibly software) that result in submission component 515 and completion component 520 carrying out their respective functions.

Submission component 515 and completion component 520 may execute without interruption or preemption: that is, when submission component 515 is executing, it might not be possible for completion component 520 to execute, and vice versa. By locking request submission component 135 so that no more than one of submission component 515 and completion component 520 is executing at any given time, it is possible to avoid storage device 120 of FIG. 1 from ending up in an inconsistent state.

In some embodiments of the disclosure, a single request submission component 135 may be used for all storage devices 120 of FIG. 1. But in other embodiments of the disclosure, addresses 410 of FIG. 4, which may span a single storage device or multiple storage devices (as may occur, for example, with a logical volume), may be divided into regions, with each region managed by different request submission components 135. By including multiple request submission components 135, efficiency may be increased, since there is no concern about a request that is managed by one request submission component 135 from conflicting with a request managed by a different request submission component 135. In some embodiments of the disclosure, the region managed by one request submission component 135 may not overlap with the region managed by another request submission component 135.

When multiple request submission components 135 are used, one per region, the region may be a subset of addresses 410 of FIG. 4 in a given storage device 120 of FIG. 1, with one (or more) other request submission components 135 managing other regions that are also subsets of addresses 410 of FIG. 4 in that storage device 120 of FIG. 1. In some embodiments of the disclosure, the region of addresses 410 of FIG. 4 managed by a given request submission component 135 may span more than one storage device 120 of FIG. 1.

When multiple request submission component 135 are used, it might happen that a particular I/O request 405 of FIG. 4 may impact multiple different regions of addresses 410 of FIG. 4, and therefore may involve multiple request submission components 135. Transaction semantics may be used to identify such requests and the impacted request submission components, similar to those used to handle I/O requests that involve multiple storage devices (for example, when using a logical volume or some other system, such as a Redundant Array of Independent Disks (RAID) that might hide the physical storage devices 120 of FIG. 1 from the system).

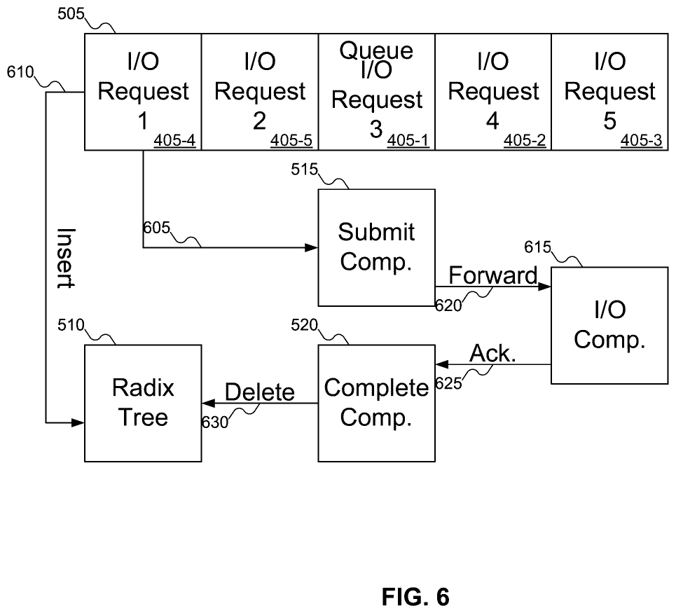

FIG. 6 shows how queue 505 of FIG. 5 and radix tree 510 of FIG. 5 may be used to manage submitting requests to storage device 120 of FIG. 1, according to embodiments of the disclosure. In FIG. 6, queue 505 is shown as including I/O requests 405-4, 410-5, 410-1, 410-2, and 410-3 (requests 405-1, 410-2, and 410-3 may be the same I/O requests as shown in FIG. 4). Queue 505 may have a head and a tail, and may include pointers (not shown in FIG. 6) to the head and tail entries in queue 505. I/O requests 405 may be inserted at the tail of queue 505, and removed from queue 505 when I/O requests 405 reach the head of queue 505. It should be understood that the terms “head” and “tail” may be interchanged without any loss of generality. When submission component 515 is operating, submission component 515 may examine the I/O request at the head of queue 505, shown as operation 605. For example, submission component 515 may examine I/O request 405-4, currently at the head of queue 505. (For purposes of this discussion, I/O requests 405 in queue 505 may be assumed to be inserted in the order in which they were issued. Thus, I/O request 405-4 may have been issued before I/O request 405-5, which may have been issued before I/O request 405-1, and so on.) Submission component 515 may then compare the addresses 410 of FIG. 4 that are to be accessed according to I/O request 405-4, and may compare those addresses 410-4 with addresses 410 in radix tree 510. If there is no conflict, or overlap, between I/O request 405-4 and addresses 410 of FIG. 4 in radix tree 510, then submission component 515 may execute insert operation 610 to add the addresses accessed by I/O request 405-4 to radix tree 510, after which submission component 615 may remove I/O request 405-4 from queue 505 and may forward I/O request 405-4 as operation 620 to I/O component 615. (I/O component 615 may include the appropriate hardware and/or software to deliver I/O request 405-4 to storage device 120 of FIG. 1: for example, I/O component 615 may include device driver 130 of FIG. 1 and/or any appropriate hardware to deliver or otherwise notify storage device 120 of FIG. 1 about I/O request 405-4).

If there is a conflict, or overlap, between I/O request 405-4 and addresses 410 of FIG. 4 in radix tree 510, then that means that at least one address 410 of FIG. 4 being accessed by I/O request 405-4 is being accessed by an in-flight I/O request. In that case, submission component 515 may delay forwarding I/O request 405-4 to I/O component 615 until the conflict is resolved.

The conflict in question may be resolved by completion component 520. As shown in FIG. 6, I/O component 615 may deliver acknowledgement 625, which may also be termed a completion message, to completion component 520. Completion component 520 may then execute (provided that submission component 515 is not currently executing). Upon receiving acknowledgement 625, completion component 520 may then execute delete operation 630 on radix tree 510 to remove the addresses being accessed by the I/O request that has now completed. This, in turn, may free submission component 515 to insert the addresses accessed by I/O request 405-4 to radix tree 510, to remove I/O request 415-4 from queue 505, and to forward I/O request 405-4 to I/O component 615.

Note that in some embodiments of the disclosure, submission component 515 and completion component 520 may execute independently of each other (subject to the expectation that they do not execute at the same time). But in other embodiments of the disclosure, submission component 515 and completion component 520 may each trigger the other when their own functioning is as complete as possible. Thus, for example, after completion component 520 processes acknowledgement 625, completion component 520 may signal submission component 515 that it may resume execution, as I/O request 405-4 (at the head of queue 505) may now be eligible for forwarding to I/O component 615.

There are various modifications that may be made to the above basic strategy. For example, the above discussion does not state what might happen to, say, I/O request 405-5 if I/O request 405-4 is delayed due to a conflict. In some embodiments of the disclosure, if an I/O request 405 at the head of queue 505 is delayed due to a conflict, then any other I/O requests 405 in queue 505 may also be delayed, in an attempt to keep storage device 120 of FIG. 1 executing I/O requests 405 in order. But if I/O request 405-5 does not conflict with any addresses 410 of FIG. 4 in radix tree 510, there is no reason that I/O request 405-5 could not be forwarded to storage device 120 of FIG. 1 even though an earlier-submitted I/O request 405 is delayed in queue 505 (and, of course, updating radix tree 510 to reflect that I/O request 405-5 has been marked as in-flight). Thus, in such embodiments of the disclosure, submission component 515 might not stop examining I/O requests 405 when I/O request 405-4 is delayed due to a conflict, and may continue to examine the other I/O requests 405 in queue 505. (Since I/O request 405-4 would still be at the head of queue 505, marking I/O request 405-5 as in-flight may involve flagging I/O request 405-5 as in-flight even without removing it from queue 505, or it might involve removing I/O request 405-5 from queue 505 and advancing all later I/O requests 405 to avoid any gaps in queue 505.) But the time required for submission component 515 to examine queue 505 in its entirety is proportional to the number of entries in queue 505. If submission component 515 examines every I/O request 405 in queue 505 every time it executes, then submission component 515 may tend to dominate over completion component 520. Thus, rather than examining every I/O request 405 in queue 505 every time submission component 515 executes, submission component 515 might examine I/O requests 405 in queue 505 only until some condition(s) is/are reached, after which submission component 515 may stop executing (and give completion component 520 an opportunity to execute). The condition(s) used to terminate execution of submission component 515 may be any desired condition(s). For example, submission component 515 might only look at a certain number of I/O requests 405 in queue 505 at a time: for example, five I/O requests 405. Or, submission component 515 might examine I/O requests 405 in queue 505 until an I/O request 405 is delayed due to a conflict with an address 410 of FIG. 4 in radix tree 510, after which some additional number of I/O requests 405 in queue 505, say five I/O requests 405, are examined, after which execution of submission component 515 stops. Or, submission component 515 might execute until some number of I/O requests 405, for example, three I/O requests 405, are delayed due to conflict with an address 410 of FIG. 4 in radix tree 510, after which execution of submission component 515 stops.

Another modification that may be used is to manage two radix trees 510: one for write requests and one for read requests. That is, addresses 410 of FIG. 4 that are accessed by write requests may be tracked separately from addresses 410 of FIG. 4 that are accessed by read requests. By separately tracking write and read requests, it may be possible to expedite multiple read requests 405 by only examining addresses 410 of FIG. 4 in the write radix tree 510: there is no problem with multiple read requests being processed in parallel. As long as the address being accessed by read request 405 is not being written to by a pending write request, read request 405 may proceed. But if the address being accessed by read request 405 is also being written to by an earlier write request 405, then read request 405 may block until the earlier write request 405 completes, to avoid reading stale data. Of course, such a modification may also require that the read radix tree 510 track identifiers of the read requests 405 that access those addresses 410 of FIG. 4, to avoid removing an address 410 of FIG. 4 from the read radix tree 510 when there are still in-flight read requests that access those addresses 410 of FIG. 4. In addition, write requests 405 may now involve examining both the write radix tree 510 and the read radix tree 510, since the write request 405 might access an address that is accessed by some other in-flight request, which could be either a write request or a read request.

By separating radix tree 510 into a write radix tree 510 and a read radix tree 510, it may also be possible to coalesce multiple write requests 405. For example, if a particular address 410 of FIG. 4 is found only in the write radix tree 510 (and not in the read radix tree 510), then there is no concern that coalescing two write requests 405 might affect an intervening read request 405.

In some embodiments of the disclosure, the implementations of submission component 515 and completion component 520 may be implemented using open source software. Using open source software may enable variations to accommodate particular implementations of the embodiments of the disclosure, and may enable easy implementation in other systems.

While the above discussion illustrates example implementations for submission component 515 and completion component 520, embodiments of the disclosure may support any desired approaches for dequeuing I/O requests 405 from queue 505. Any desired approaches for implementing submission component 515 and completion component 520 may be used.

FIG. 7 shows details of logical block index manager 140 of FIG. 1, according to embodiments of the disclosure. In FIG. 7, logical block index manager 140 may include block allocation component 705, receiver 710, hash function 715, bitmap 720, state machine 725, mapping table 730, and request generator 735. Block allocation component 705 may allocate blocks on storage device 120 of FIG. 1. In some embodiments of the disclosure, logical block index manager 140 may operate based on a logical volume, rather than based on the total capacity of storage device 120 of FIG. 1. That is, applications may initially specify the size of a volume the application requests access to. Logical block index manager 140 may then establish a logical volume based on this request. The application might specify the capacity is bytes (or some multiple thereof, such as MBs, gigabytes (GB), or TBs), or the application might specify the size of the block to be used and the number of blocks requested. Either way, logical block index manager 140 may be able to use block allocation component 705 to allocate a logical volume sufficient for the application. Note that in some embodiments of the disclosure, a given logical volume might span multiple physical storage devices 120 of FIG. 1. From here on, any reference to storage device 120 or to a logical volume may be understood as referring to the other as well.

Receiver 710 may receive requests to access data from storage device 120 of FIG. 1. These requests may specify, for example, requests to read, write, or delete data on storage device 120, among other possibilities. Note that in some embodiments of the disclosure, these requests may be block requests, with the request including a logical block address associated with the data; in other embodiments of the disclosure, these requests may be key-value requests, with the request including a key associated with the data. The names assigned to these requests may therefore vary (for example, GET vs. READ, PUT vs. WRITE), but the underlying intent of the requests are essentially the same: only the implementation of the requests may vary.

Embodiments of the disclosure may support using storage devices that support block requests, even if the application might be issuing key-value requests. That is, logical block index manager 140 may manage mapping key-value requests to block requests, enabling storage of data on a block-based storage device even while the application issues key-value requests. But embodiments of the disclosure may also support handling of block-based requests from the application. In the remainder of this document, the identifier will be treated as a key from a key-value request, but it should be understood that the identifier may also be a logical block address or any other type of identifier, without loss of generality.

Hash function 715 may be used to generate a hash based on some identifier in the request. This hash may then be treated as a block identifier. Thus, hash function 715 may map from any identifier that might be used by the application (be it a logical address or a key) to a number that may range from one to the number of blocks in the logical volume (or in storage device 120 of FIG. 1, depending on the implementation). In some embodiments of the disclosure, where block numbers may start at zero instead of one, the block number may range from zero to one less than the total number of blocks in the logical volume (or storage device 120 of FIG. 1). Any desired hash function may be used, although there are advantages to hash functions that distribute the results across the entire range of possible values, to reduce the possibility of collisions.

The block identifier may identify a particular block in storage device 120 of FIG. 1. This block may be used to store information about the key (or other information) in the request received by receiver 710. The data in the request received by receiver 710 may then be stored in other blocks. Ideally, the block that stores the key information and the blocks that store the data form a contiguous set of blocks in storage device 120. That is, if block n is identified by the block identifier, then blocks n+1 through n+k may store the data, assuming that the data is large enough to span k blocks.

If it does not happen to be that there are k blocks free after the block identified by the block identifier generated by hash function 715, then another sufficiently large contiguous set of blocks may be found. If there is no contiguous set of k blocks on storage device 120 of FIG. 1, then the data may be stored in blocks where available, although it may be desirable to keep the blocks storing the data as compact as possible.

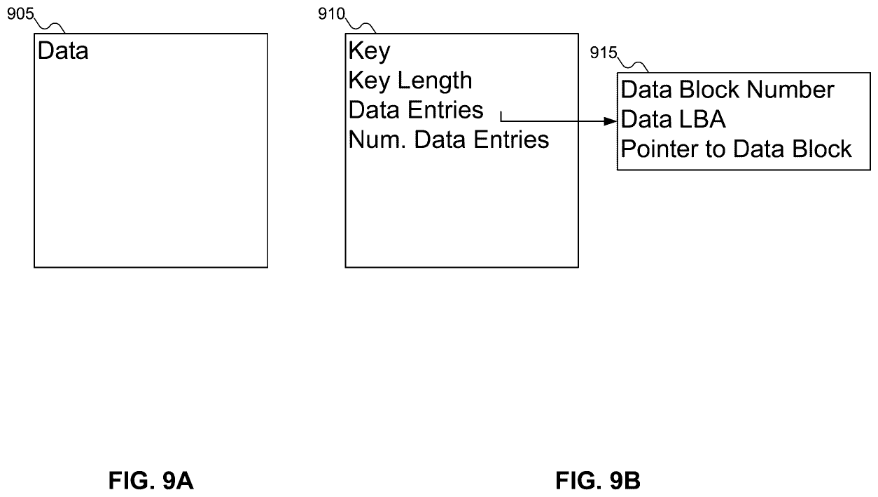

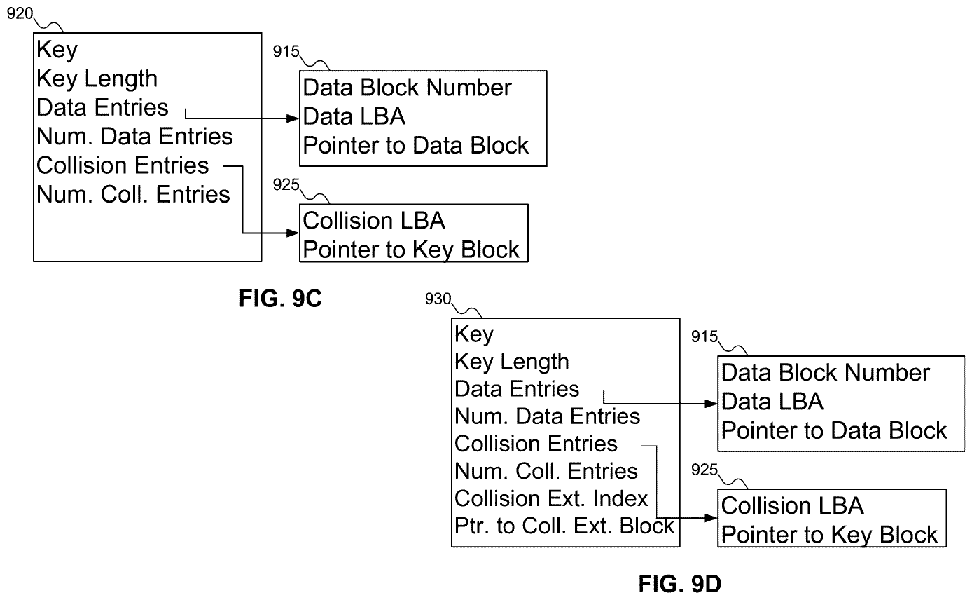

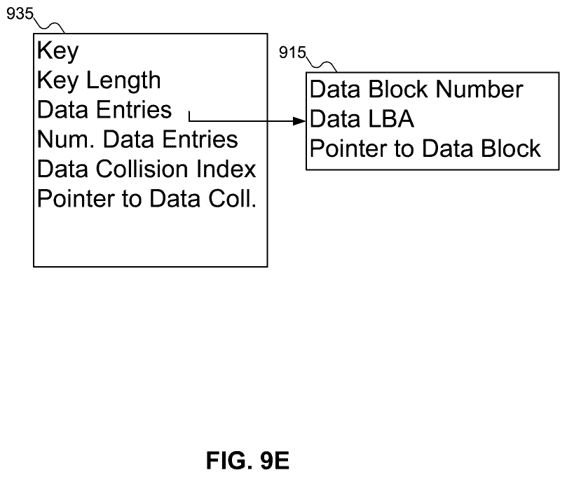

Bitmap 720 may store information about how data is managed on storage device 120 of FIG. 1. As discussed with reference to FIGS. 9A-9E below, there are various different types of blocks that may be stored on storage device 120 of FIG. 1: bitmap 720 may track what data is stored in each block in storage device 120 of FIG. 1. Given the relatively small number of different types of blocks (free blocks, key blocks, key collision blocks, key collision extension blocks, value blocks, data collision blocks, and data collision meta blocks) only a few bits are needed per block to track the different types of blocks stored on storage device 120 of FIG. 1. Thus, depending on the size of each block on storage device 120 of FIG. 1, bitmap 720 might require only two megabytes (MB) to represent 16 terabytes (TB) of storage in storage device 120 of FIG. 1. The size of bitmap 720 may be seen as proportional to the total capacity of storage device 120 of FIG. 1, and inversely proportional to the size of an individual block stored on storage device 120 of FIG. 1. In embodiments of the disclosure where logical volumes are used, bitmap 720 may be specific for the logical volume, rather than for the entirety of storage device 120 of FIG. 1.

Logical block index manager 140 may use bitmap 720 for various purposes. For example, bitmap 720 may be used to identify which blocks are free to store data in response to new write requests from an application. After hash function 715 has generated a block identifier from the identifier in an I/O request (particularly to store data on storage device 120 of FIG. 1), logical block index manager 140 may check bitmap 720 to determine if that block is free or not. If that block is free, then logical block index manager 140 may set that block to a key state; if that block is not free, then based on its current state logical block index manager 140 may update that block's state (which new state may depend on the current state of the block).

Logical block index manager 140 may also use bitmap 720 to identify the blocks into which new data to be written should be stored. As discussed with reference to FIG. 9B below, logical block index manager 140 may select a contiguous set of blocks on storage device 120 of FIG. 1 to store the data for the original request from the application. The number of blocks to be used may be determined by comparing the size of the data to be written with the size of an individual block. Logical block index manager 140 may then review bitmap 720 to determine if there is a contiguous set of free blocks on storage device 120 of FIG. 1 large enough to store the data. In some embodiments of the disclosure, this contiguous set of blocks may be located contiguous with the block storing information about the key (or other identifier); in other embodiments of the disclosure, the data may be stored as a contiguous block elsewhere on storage device 120 of FIG. 1 (not adjacent to the block storing the information about the key), or even broken up so that different portions of the data are stored in various noncontiguous blocks on storage device 120 of FIG. 1.

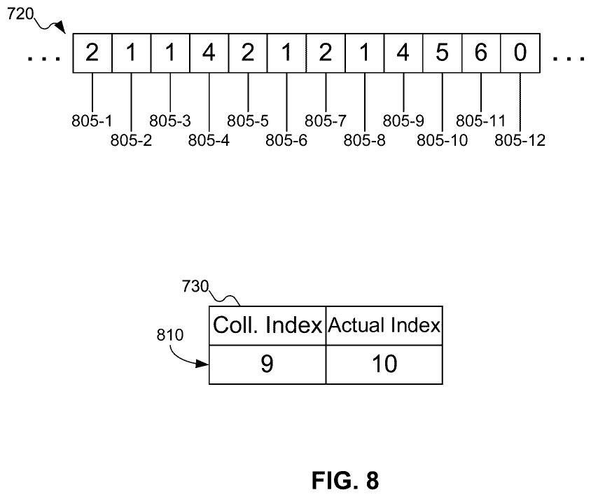

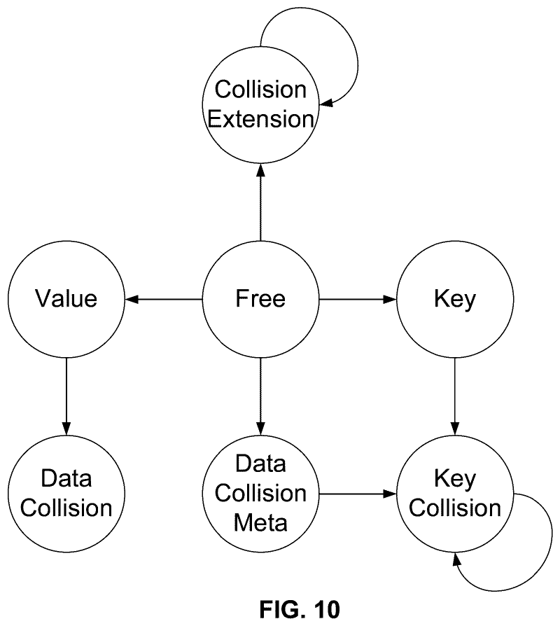

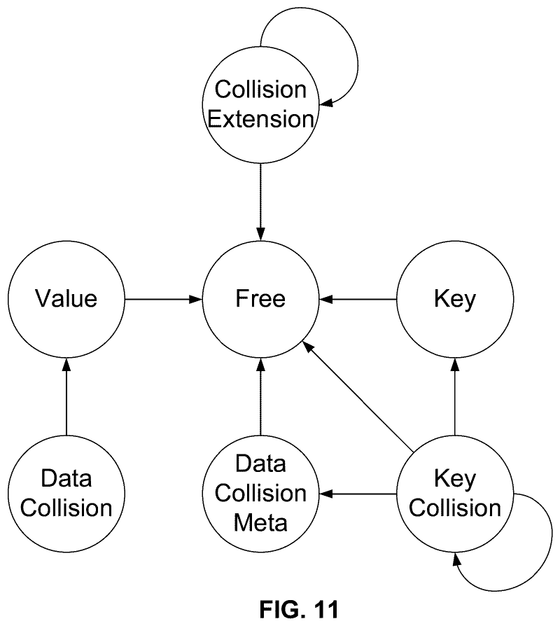

As discussed above and further with reference to FIG. 8 below, bitmap 720 may store the states of various blocks on storage device 120 of FIG. 1. The states of these blocks may change as data is added to or removed from storage device 120 of FIG. 1 State machine 725 may manage the transitions of the states of these blocks, based on their current state and what changes are being made to the data stored on storage device 120 of FIG. 1. FIGS. 10-11 below discuss these various state transitions that may be managed by state machine 725.

Mapping table 730 may be used when collisions occur in the use of hash function 715. Specifically, mapping table 730 may be accessed to determine if a hash collision has occurred, to identify the block to be used instead of the block identified by hash function 715. Thus, after hash function 715 generates a block identifier, mapping table 730 may be accessed to determine if that block identifier is mapped to a different block identifier, which may then be used. As discussed with reference to FIGS. 9A-9E below, mapping table 730 may be used to address some hash collisions, whereas other hash collisions may be handled without using mapping table 730.

Bitmap 720 and mapping table 730 may be stored in memory 115 of FIG. 1, in a memory associated with logical block index manager 140, or a combination of the two. Further, bitmap 720 and mapping table 730 may be stored in different memories: they do not need to be stored in the same memory.

Request generator 735 may generate a request to be sent to storage device 120 of FIG. 1. The request may be, for example, a block request, even though the request received by receiver 710 might have been a key-value request. The request generated by request generator 735 may use blocks selected based on the block identifier generated by hash function 715. Request generator 735 may, for example, use the block identifier generated by hash function 715 to determine a logical block address that may be used with the request, so that the data is ultimately stored in the expected block in storage device 120 of FIG. 1.

While the above discussion focuses on how logical block index manager 140 may be used to write data to storage device 120 of FIG. 1, logical block index manager 140 may also be used to manage reading data from storage device 120 of FIG. 1, or deleting data from storage device 120 of FIG. 1. For example, in response to receiver 710 receiving a request from an application to read or delete data, logical block index manager 140 may use hash function 715 to generate a block identifier that identifies where the key block for that request is stored on storage device 120 of FIG. 1. Bitmap 720 may also reflect if bitmap 720 indicates some sort of hash collision, in which case mapping table 730 may be used to determine if the block identifier is the correct block identifier or if another block identifier might be the correct block identifier. Request generator 735 may then generate the request to be sent to storage device 120 of FIG. 1 to access the appropriate block(s) storing the relevant data in response to the application's original request. As discussed with reference to FIGS. 9A-9E below, in case there is a hash collision, request generator 735 may generate a request to access a block that may include identifiers of or pointers to other blocks that may be relevant to the original request from the application.

FIG. 8 shows details of bitmap 720 of FIG. 7 and mapping table 730 of FIG. 7, according to embodiments of the disclosure. In FIG. 8, bitmap 720 is shown as including various values Bitmap 720 is shown as including entries 805-1 through 805-12, each of which may represent a state of a corresponding block in storage device 120 of FIG. 1. Entries 805-1 through 805-12 may be referred to collectively as entries 805 or states 805. While FIG. 8 shows 12 entries 805, embodiments of the disclosure may include any number of entries 805.

Each entry 805 in bitmap 720 may represent a particular block in storage device 120 of FIG. 1 (or in a logical volume). Thus, different values may be used to represent the state of each block on storage device 120 of FIG. 1. For example, a value of 0 may represent that a block is currently free (a free block, not used for any purpose), a value of 1 may identify a block that stores data (a value block), a value of 2 may identify a block that stores a key (a key block), a value of 3 may identify a block that stores a key collision (a key collision block), a value of 4 may identify a block that stores a collision extension (a key collision extension block), a value of 5 may identify a block that stores a data collision (a data collision block), and a value of 6 may identify a block that stores data collision meta data (a data collision meta block). Each of types of blocks is explained further with reference to FIGS. 9A-9E (except for a free block, which may be understood to be a block that does not currently store any type of data).

Mapping table 730 is shown as including entry 810, showing a mapping from one block identifier, which may be a data collision block, to another block identifier, which may be a data collision meta block. Entry 810 may show, for example, that block identifier 9, which may correspond to entry 805-10 in bitmap 720, which may be a data collision block, is mapped to block identifier 10, which may correspond to entry 805-11 in bitmap 720, which may be a data collision meta block. (Data collision blocks and data collision meta blocks are discussed further with reference to FIG. 9E below.) While FIG. 8 shows mapping table 730 as including only one entry 810, embodiments of the disclosure may include any number (zero or more) of entries 810 in mapping table 730. In some embodiments of the disclosure, mapping table 730 may be an unsorted list of mappings; in other embodiments of the disclosure, mapping table 730 may sort entries 810 in any desired manner (which may expedite locating the desired block on storage device 120 of FIG. 1). In addition, while FIG. 8 shows mapping table 730 as including only the original block identifier and the mapped block identifier, embodiments of the disclosure may include additional information in mapping table 730. For example, to simplify locating the appropriate block identifier when there are multiple hash collisions on the original block identifier generated by hash function 715 of FIG. 7, mapping table 730 may also store the identifier used as input to hash function 715 of FIG. 7: the combination of the original identifier used as input to hash function 715 of FIG. 7 and the block identifier generated by hash function 715 of FIG. 7 may uniquely identify an entry 810 in mapping table 730.

As discussed further with reference to FIG. 9E, when a hash collision occurs on a block storing data, there may not be room in the block to store key information. But the key information should be stored somewhere. Mapping table 730 may store information about where the key information is actually stored, so that the key may be located. Thus, for example, if the same key is later provided, the hash function may return the block identifier of the block storing data that caused the collision. Upon seeing that the block in question is not a key block of some sort, logical block index manager 140 of FIG. 1 may then access mapping table 730 to determine which other block identifier might identify the block that stores the key information. Note that since mapping table 730 may be used when a hash collision occurs with a data block of some sort, mapping table might be relatively short compared to bitmap 720.

FIG. 9A shows details of a block used to store a value in storage device 120 of FIG. 1, according to embodiments of the disclosure. In FIG. 9A, value block 905 may store data. Value block 905 may also be referred to as a data block. As such, other than storing the actual data, value block 905 does not need to include any additional information (other than, perhaps, a field storing the state of the data block: the other types of blocks shown in FIGS. 9B-9E may also store state information).

Although not shown in FIG. 9A, value block 905 may also include a copy of its own state. The same is true for other types of blocks as shown in FIGS. 9B-9E, as well as other types of blocks. As mentioned with reference to FIGS. 9B and 9E below, and as discussed further with reference to FIG. 22 below, there may be situations in which bitmap 720 of FIG. 7 may need to be rebuilt. By storing the state of each block in the block, rebuilding bitmap 720 of FIG. 7 may be enabled.

FIG. 9B shows details of a block used to store a key in storage device 120 of FIG. 1, according to embodiments of the disclosure. In FIG. 9B, key block 910 may store a key. Other information that may be stored in key block 910 may include the length of the key, various data entries, and the number of data entries included.

Each data entry 915 may identify a block number (or other block identifier) where the data (or part of the data) may be stored, and a logical block address (or other identifier used by the application) to represent the data. In embodiments of the disclosure where the data block number uniquely identifies the block on storage device 120 of FIG. 1 where the data is stored, this may suffice for data entry 915; otherwise, data entry 915 may also include a pointer to the data block.

Note that the use of data entries 915 may involve multiple requests to access data from storage device 120. While bitmap 720 of FIG. 7 may be used to identify which blocks on storage device 120 of FIG. 1 are free to store value blocks 905 of FIG. 9A (so that logical block index manager 140 may select blocks on storage device 120 of FIG. 1 to store value blocks 905 of FIG. 9A), accessing those individual blocks may involve additional requests (whether to read or write those blocks). As discussed further below, logical block index manager 140 may also perform prefetching of value blocks 905 of FIG. 9A after fetching key block 910 based on the block identifiers stored in data entries 915.

Data entries 915 may all be the same size, which may simplify locating individual value blocks 905 of FIG. 9A. If all data entries 915 are stored within key block 910, then the n^{th} data block may be identified by multiplying the size of data entry 915 by n, and adding the offset of the first data entry 915. Alternatively, if each data entry 915 may be of varying size, then other data structures may be used to store or otherwise identify where within key block 910 each data entry 915 is stored.

The question might arise as to why there might be more than one data entry 915 in key block 910. The answer is that the size of the data is not necessarily fixed. If the data fits into a single value block 905 of FIG. 9A, then only one data entry is needed. But if the data is larger than would fit in a single value block 905 of FIG. 9A, then additional value blocks 905 of FIG. 9A may be needed. Each value block 905 of FIG. 9A may be identified via data entries 915 in key block 910.

Another question that might arise is why key block 910 might not include only one data entry 915, with additional value blocks 905 of FIG. 9A identified simply because they are consecutive blocks in storage device 120 of FIG. 1. While it is true that key block 910 and value blocks 905 of FIG. 9A that store the data associated with that key are ideally stored consecutively in storage device 120 of FIG. 1, such is not always possible. For example, the first request (and potentially many other requests) to store data on storage device 120 of FIG. 1 might be able to store key block 910 and value blocks 905 of FIG. 9A in a contiguous set of blocks, eventually storage device 120 of FIG. 1 might become sufficiently full that there is no contiguous set of blocks in storage device 120 of FIG. 1 sufficient to store a further request to store data on storage device 120 of FIG. 1. In that case, there may be no option but to store key block 910 and value blocks 905 of FIG. 9A in non-consecutive blocks on storage device 120 of FIG. 1. Further, bear in mind that the identifier of key block 910 may be determined by hash function 715 of FIG. 7. It might happen that while the block identified by the block identifier returned by hash function 715 of FIG. 7 might be free, there might not be sufficient blocks after key block 910 to store all of the data in value blocks 905 of FIG. 9 before encountering another block that is in use. In that case, the block identified by hash function 715 of FIG. 7 may be used to store key block 910, but value blocks 905 of FIG. 9A may not all fit consecutively on storage device 120 of FIG. 1.

Further, storing information about how many value blocks 905 of FIG. 9A are associated with key block 910 (by including data entries 915 for each value block 905 of FIG. 9A) may have other benefits. For example, consider the situation where key block 910 and data blocks 905 of FIG. 9A are all consecutive. To put this in more concrete terms, assume that address 410-1 of FIG. 4 stores key block 910, and addresses 410-2 through 410-5 of FIG. 4 store value blocks 905 of FIG. 9A associated with key block 910. Further, assume that for whatever reason, address 410-6 of FIG. 4 stores a value block 905 of FIG. 9A associated with some other key block 910 (for example, that address 410-6 of FIG. 4 is the start of enough blocks to store the data for that request, but key block 910 for that request was stored somewhere else due to hash function 715 of FIG. 7). If key block 910 does not store identifiers or pointers to value blocks 905 of FIG. 9A, how would machine 105 of FIG. 1 be able to know that address 410-6 of FIG. 4 does not store data that is associated with key block 910? After all, address 410-6 of FIG. 4 is contiguous with address blocks 410-2 through 410-5 of FIG. 4, and is a data block, so it would appear to be part of the data associated with key block 910. But by storing data entries 915, it may be determined that address 410-6 of FIG. 4 is not associated with key block 910 stored at address 410-1 of FIG. 4, since address 410-6 of FIG. 4 is not included in a data entry 915 associated with key block 910.

Thus, since there are various situations where the data may not be stored in consecutive value blocks 905 of FIG. 9A after key block 910, or where other data may be stored consecutively to value blocks 905 of FIG. 9A associated with key block 910, using data entries 915 may enable clear determination of what value blocks 905 of FIG. 9A are associated with key block 910, and what value blocks 905 of FIG. 9A are not so associated.

Yet another question might arise: why not store information about the block identifiers for value blocks 905 of FIG. 9A that are associated with key block 910 in bitmap 720 of FIG. 7, rather than in data entries 915? In some embodiments of the disclosure, the information stored in data entries 915 may also be stored in bitmap 720 of FIG. 7. But there are various reasons why some embodiments of the disclosure might leave such information in data entries 915 rather than in bitmap 720 of FIG. 7. First, as discussed with reference to FIGS. 9A-9E, bitmap 720 of FIG. 7 and mapping table 730 of FIG. 7 are stored in volatile storage, they may be lost if power is interrupted. By storing data entries 915 with key block 910, it may be possible to rebuild bitmap 720 of FIG. 7 and mapping table 730 of FIG. 7 after power is interrupted. (Of course, bitmap 720 of FIG. 7 may store the information from data entries 915 as well: but storing data entries 915 with key block 910 enables rebuilding bitmap 720 of FIG. 7 and mapping table 915 after a power interruption.) In addition, as discussed with reference to FIG. 7 above, bitmap 720 of FIG. 7 may be relatively small because only state information is stored in bitmap 720 of FIG. 7. By storing information about which value blocks 905 of FIG. 9A are associated with a particular key block 910 in bitmap 720 of FIG. 7, the size of bitmap 720 of FIG. 7 may increase significantly. Since volatile storage may be relatively expensive as compared with non-volatile storage—for example, DRAM may cost approximately 30 times as much as flash memory on a per-GB basis—it is desirable to minimize the amount of DRAM included in a system to reduce cost, and storing more information in bitmap 720 of FIG. 7 may involve a larger amount of DRAM in a system.

FIG. 9C shows details of a block used to store a key collision in storage device 120 of FIG. 1, according to embodiments of the disclosure. In FIG. 9C, key collision block 920 is similar to key block 910 of FIG. 9B. But when hash function 715 of FIG. 7 results in a hash collision on key block 910 of FIG. 9B, key block 910 of FIG. 9 may be updated to key collision block 920. (Note that whenever a block state is updated in this manner, either here or when any block state is changed—including changing from a free block state to a key block state or a value block state—bitmap 720 of FIG. 7 may also be updated to reflect the change in state of the block.) Key collision block 920 may also store collision entries, as well as the number of collision entries 925. Each collision entry may represent a different key that was hashed by hash function 715 to the block identifier for key collision block 920. Since key collision block 920 already stores information about a key, collision entry 925 may store an identifier (such as the logical block address) and/or a pointer to another block on storage device 120 of FIG. 1 where key block 915 of FIG. 9B is actually stored. (This block may be a standard key block 915 of FIG. 9B, since there would be no collision yet associated with that block: a free block may be selected on storage device 120 of FIG. 1 to store key block 915 of FIG. 9B for the current request.) As with data entries 915, there may be more than one collision entry 925, depending on the number of hash collisions generated by hash function 715 of FIG. 7.

Collision entries 925 may all be the same size, which may simplify locating individual value blocks 905 of FIG. 9A. If all collision entries 925 are stored within key collision block 920, then the n^{th} data block may be identified by multiplying the size of collision entry 925 by n, and adding the offset of the first collision entry 925. Alternatively, if each collision entry 925 may be of varying size, then other data structures may be used to store or otherwise identify where within key collision block 920 each collision entry 925 is stored.

While the number of collisions that might occur is theoretically unbounded, from a practical point of view the size of key collision block 920 may limit the number of collisions that may be stored in key collision block 920. For example, between the size of a block and amount of information otherwise stored in key collision block 920, there may be an upper bound (for example, two) to the number of collision entries 925 that may be stored in key collision block 920. In that case, a key collision extension block may be used, as shown in FIG. 9D.

FIG. 9D shows details of a block used to store a key collision extension in storage device 120 of FIG. 1, according to embodiments of the disclosure. In FIG. 9D, key collision block 930 is shown. Key collision block 930 is similar to key collision block 920 of FIG. 9C, except that key collision block 930 also includes a collision extension index identifying a collision extension block and/or a pointer to the collision extension block. The key collision extension block may be selected from a free block on storage device 120. The key collision extension block may function like key block 910 of FIG. 9B, except that its state may be identified as a key collision extension block rather than as a key block (the reason for this different state is to deal with the situation where a hash collision might occur on the key collision extension block itself). Thus, the key collision block may store the same information as key block 910 of FIG. 9 (and may be updated like key collision block 920 of FIG. 9C should there be yet another hash collision on the original key block, although still retaining its state as a key collision extension block).

FIG. 9E shows details of a block used to store a data collision metadata in storage device 120 of FIG. 1, according to embodiments of the disclosure. In FIGS. 9C-9D above, the discussion focuses on what happens if a hash collision occurs on a block that stores key data (such as key block 910 of FIG. 9B or key collision block 920 of FIG. 9C). But what if a hash collision occurs on a data block: that is, on block 905 of FIG. 9A storing data associated with some key block 910 of FIG. 9B? Since value block 905 of FIG. 9A is likely full storing data, there might not be room to store key collision information as with key collision block 920 of FIG. 9C.

The solution is to change the state of value block 905 of FIG. 9A to a data collision block (this change should not be a problem, since bits are already used to represent the state of the block: only the value assigned to those bits is being changed). A new free block on storage device 120 of FIG. 1 may be selected, and data collision meta block 935 may be stored in that block on storage device 120 of FIG. 1. Note that data collision meta block 935 is very similar to key block 910 of FIG. 9B, except that the state is different and data collision meta block 935 may include a data collision index and/or a pointer to the data collision block. The data collision index may be the index of value block 905 of FIG. 9A where the hash collision occurred; the pointer to the data collision block may be a pointer to that block as well. Finally, mapping table 730 of FIG. 7 may be updated to include entry 810 of FIG. 8, so that when it is determined from bitmap 720 of FIG. 7 that the block identified by hash function 715 of FIG. 7 is a data collision block, mapping table 730 of FIG. 7 may be examined to find another block identifier for the key block.

Note that multiple hash collisions on the same data block may result in multiple entries 810 of FIG. 8 in mapping table 730 of FIG. 7. There are various possible implementations that may be used to handle multiple hash collisions. One approach recognizes that the likelihood of multiple hash collisions on a single data block is relatively low. In that case, it may be adequate to simply include multiple entries 810 of FIG. 8 mapping the block identifier returned by hash function 715 of FIG. 7 to multiple block identifiers: one for each collision. But if the concern about hash collisions is sufficient, mapping table 730 of FIG. 7 may be modified to include the key associated with each hash collision as well, to permit unique identification of an entry 810 of FIG. 8 in mapping table 730 of FIG. 7 after a hash collision. Mapping table 730 of FIG. 7 may also be modified to map a block identifier returned by hash function 715 of FIG. 7 to a data structure that may store multiple other block identifiers, so that mapping table 730 of FIG. 7 does not need to be examined more than once (in case there are multiple hash collisions to the same value block 905 of FIG. 9A).

But as an objective may be to minimize the footprint in memory 115 of FIG. 1 for bitmap 720 of FIG. 7 and mapping table 730 of FIG. 7, it may be preferable to minimize the number of entries in mapping table 730 of FIG. 7. In that case, entry 810 of FIG. 8 may map from data block 905 of FIG. 9A where the hash collision occurred to a block where the new key data is stored. This block storing the key data (previously key block 910 of FIG. 9B) may be updated to key collision block 920 of FIG. 9C, just like when there is a hash collision on key block 910 of FIG. 9B. (If necessary, key collision extension block 930 of FIG. 9D may also be used.) In this manner, only one entry 810 of FIG. 8 is needed, regardless of the number of hash collisions that occurred with that data block 905 of FIG. 9A.

By storing all the various blocks shown in FIGS. 9A-9E, and by storing the states of each block in each block, embodiments of the disclosure enable reconstructing bitmap 720 of FIG. 7 and mapping table 730 of FIG. 7 should they be lost. For example, bitmap 720 of FIG. 7 and mapping table 730 of FIG. 7 might be stored in main memory 115 of FIG. 1 or in some other volatile memory. In such situations, if machine 105 of FIG. 1 should experience a power interruption, bitmap 720 of FIG. 7 and/or mapping table 730 of FIG. 7 might be lost or corrupted due to the power interruption. But by examining the state of each block on storage device 120 of FIG. 1, bitmap 720 may be reconstructed. In addition, as data collision meta blocks 935 of FIG. 9E may store information about the block identifier for the original value block where the hash collision occurred, entries 810 of FIG. 8 in mapping table 730 of FIG. 7 may be reconstructed as well.

FIG. 10 shows a state transition diagram for the states of blocks being written to storage device 120 of FIG. 1, according to embodiments of the disclosure. The state transitions shown in FIG. 10 may be managed by state machine 725 of FIG. 7. In FIG. 10, a block may start in a free block state. The block may then transition to any of a value state, a key state, a key collision extension state (if there was a hash collision on a key collision block that did not have room to store another collision), or a data collision meta block (if there was a hash collision on a value block). A value block may change state to a data collision block if there is a hash collision on the index of the value block. A key block may change state to a key collision block if there is a hash collision on the index of the key block. And a data collision meta block may change state to a key collision block if there is a hash collision on the index of the data collision meta block (note that by the time this might happen, entry 810 of FIG. 8 in mapping table 730 of FIG. 7 from the original value block to the data collision meta block has already been added, so no data is lost, although key collision block 920 of FIG. 9 might be modified to retain the data collision index and/or the pointer to the data collision block as shown in data collision meta block 935 of FIG. 9E).

FIG. 11 shows a state transition diagram for the states of blocks being deleted from storage device 120 of FIG. 1, according to embodiments of the disclosure. The state transitions shown in FIG. 10 may be managed by state machine 725 of FIG. 7. In FIG. 11, a value block and/or a key block may change state to a free block when the information stored in those blocks is deleted. A key collision extension block may change state to a free block if all keys in the key collision extension block are removed. A key collision block may change state to a key block if the number of collision entries 925 of FIG. 9C is reduced to zero. A key collision block may also change state to a data collision meta block if the number of collision entries 925 of FIG. 9C is reduced to zero, but there is a data collision index or a pointer to a data collision block. A key collision block may also change state to a free block if the number of collisions is reduced to zero and the key originally stored in the block is no longer valid (that is, that key was deleted art some point). A data collision meta block may change state to a free block if the information in the data collision meta is deleted: that is, the data collision meta block does not store a key. Finally, a data collision block may change state to a value block if the key stored in the data collision meta block is deleted (meaning that there is no hash collision remaining).

As should be understood from the above description, logical block index manager 140 of FIG. 1 may execute more than one access request to storage device 120 of FIG. 1 based on a particular I/O request from an application. For example, logical block index manager 140 of FIG. 1 may issue one access request to storage device 120 of FIG. 1 to access key block 910 of FIG. 9B, key collision block 920 of FIG. 9C or 930 of FIG. 9D, or data collision meta block 935 of FIG. 9E, and then-based on data entries 915 of FIG. 9B) may issue one or more access requests to storage device 120 of FIG. 1 to access value blocks 905 of FIG. 9A. (If the block identifier identifies key collision 920 of FIG. 9C, collision entry 925 of FIG. 9C may be accessed to locate key block 910 of FIG. 9B; if the block identifier identifies key collision block 930 of FIG. 9D, then key collision block 930 of FIG. 9D may be accessed first, then the key collision extension block may be identified and accessed before collision entry 925 of FIG. 9D may be accessed.) Thus, as may be seen, the time required to locate value blocks 905 of FIG. 9A requested by the application in the original I/O request may take some time. If the original I/O request issued by the application only requests one part of the data, and then later requests another part of the data, to repeat this process may introduce delay. Thus, after key block 910 of FIG. 9B is located, logical block index manager 140 of FIG. 1 may prefetch other data blocks identified in data entries 915 of FIG. 9B, so that the data is available without additional delay. These prefetched blocks may be stored, for example, in memory 115 of FIG. 1 or cached anywhere else desired. For example, if storage device 120 of FIG. 1 includes some local memory that is accessible to logical block index manager 140 of FIG. 1 (as may be the case with some variations of a CXL storage device), the prefetched blocks may be stored in the memory of storage device 120 of FIG. 1.

The relationship between the three related applications may now be understood. U.S. patent application Ser. No. _______, filed ______, which is incorporated by reference herein for all purposes, may receive requests from applications and may manage the states of blocks on storage device 120 of FIG. 1. Such requests may be passed to U.S. patent application Ser. No. 18/830,559, filed Sep. 10, 2024, which claims the benefit of U.S. Provisional Patent Application Ser. No. 63/635,257, filed Apr. 17, 2024, both of which are incorporated by reference herein for all purposes, may then process such requests, including allocating space on storage device 120 of FIG. 1 to satisfy such requests. Finally, U.S. Patent Application Serial No., filed which is incorporated by reference herein for all purposes, may then manage how requests are sent to storage device 120 of FIG. 1, to ensure that requests are not processed out of order.

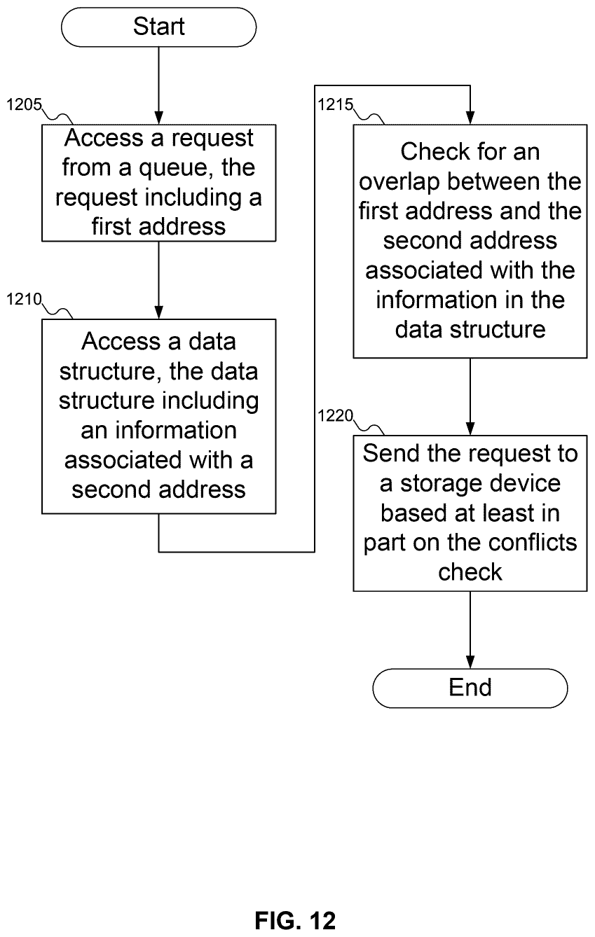

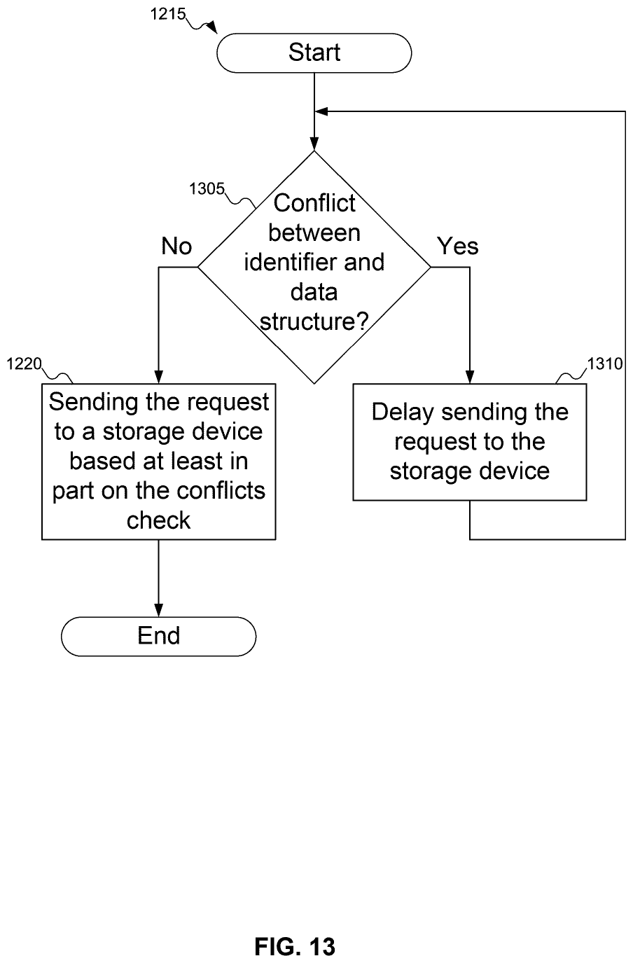

FIG. 12 shows a flowchart of an example procedure for submission component 515 of FIG. 5 to process I/O requests, according to embodiments of the disclosure. In FIG. 12, at block 1205, submission component 515 of FIG. 5 may access I/O request 410 of FIG. 4 from queue 505 of FIG. 5. The request may include an address on storage device 120 of FIG. 1 for the data being accessed. At block 1210, submission component 515 of FIG. 5 may access data structure 510 of FIG. 5. This data structure may store information about addresses associated with other requests that are already in-flight to storage device 120 of FIG. 1. At block 1215, submission component 515 of FIG. 5 may perform a conflicts check by comparing the address from request 410 of FIG. 4 in queue 505 of FIG. 5 with addresses in data structure 510 of FIG. 5. As discussed with reference to FIGS. 5-6, this conflict check may involve determining whether any address in request 410 of FIG. 4 is an address currently in radix tree 510 of FIG. 5 (and therefore is being accessed by a pending I/O request 405 of FIG. 4). If the address in request 410 of FIG. 4 is in radix tree 510 of FIG. 5, then I/O request 405 is in conflict with a pending request 405 and should be blocked; otherwise, I/O request 405 is not in conflict with a pending request, and may be sent to storage device 120 of FIG. 1. Finally, at block 1220, submission component 515 of FIG. 5 may send request 410 of FIG. 4 to storage device 120 of FIG. 1, based on the result of the conflicts check.

FIG. 13 shows a flowchart of an example procedure for request submission component 135 of FIG. 1 to determine whether to send I/O request 410 of FIG. 4 to storage device 120 of FIG. 1 or to delay sending it, according to embodiments of the disclosure. In FIG. 13, at block 1305, submission component 515 of FIG. 5 may determine if there was a conflict between the address in I/O request 410 of FIG. 4 in queue 505 and any address in data structure 510 of FIG. 5. If there was no conflict, then at block 1220 of FIG. 12 submission component 515 of FIG. 5 may send I/O request 410 of FIG. 4 in queue 505 of FIG. 5 to storage device 120 of FIG. 1 (and may remove I/O request 410 of FIG. 4 from queue 505 of FIG. 5), as I/O request 410 of FIG. 4 is now in-flight). Otherwise, at block 1310, submission component 515 of FIG. 5 may delay sending I/O request 410 of FIG. 4 in queue 505 of FIG. 5 to storage device 120 of FIG. 1: request submission component 135 of FIG. 1 may leave I/O request 410 of FIG. 4 in queue 505 and check again at a later time to see if there is still a conflict between the address in I/O request 410 of FIG. 4 in queue 505 and data structure 510 of FIG. 5.

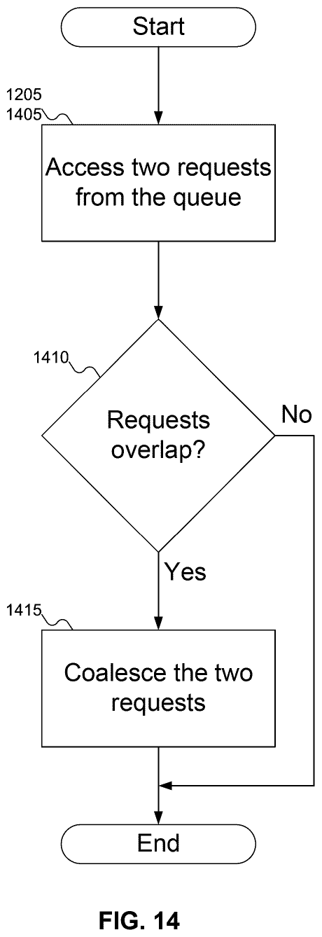

FIG. 14 shows a flowchart of an example procedure for request submission component 135 of FIG. 1 to coalesce two I/O requests, according to embodiments of the disclosure. In FIG. 14, at block 1405, request submission component 135 of FIG. 1 may access two I/O requests 410 of FIG. 4 from queue 505 of FIG. 5. One of these I/O requests may have been accessed in block 1205 of FIG. 12. At block 1410, request submission component 135 of FIG. 1 may determine if the addresses of the two I/O requests 410 of FIG. 4 overlap. If so, then at block 1415, request submission component 135 of FIG. 1 may coalesce the two I/O requests 410 of FIG. 4, eliminating any earlier data writes in the earlier I/O request 410 of FIG. 4 that are overwritten by the later I/O request 410 of FIG. 4.

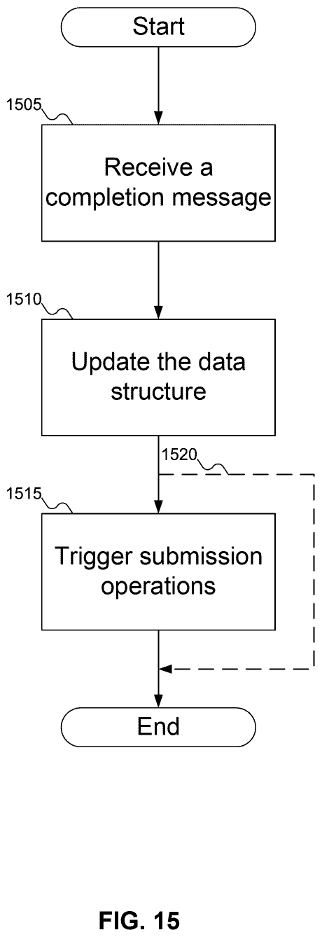

FIG. 15 shows a flowchart of an example procedure for request submission component 135 of FIG. 1 to handle completion message 625 of FIG. 6 from storage device 120 of FIG. 1, according to embodiments of the disclosure. In FIG. 15, at block 1505, request submission component 135 of FIG. 1 may receive completion message 625 of FIG. 6 from I/O component 615 of FIG. 6. At block 1510, completion component 520 of FIG. 5 may update data structure 510 of FIG. 5 to remove any addresses that were inserted into data structure 515 of FIG. 5 based on the I/O request 410 of FIG. 4 associated with completion message 625 of FIG. 6. Finally, at block 1515, completion component 520 of FIG. 5 may trigger execution of submission component 515 of FIG. 5. Note that block 1515 is optional, as shown by dashed line 1520.

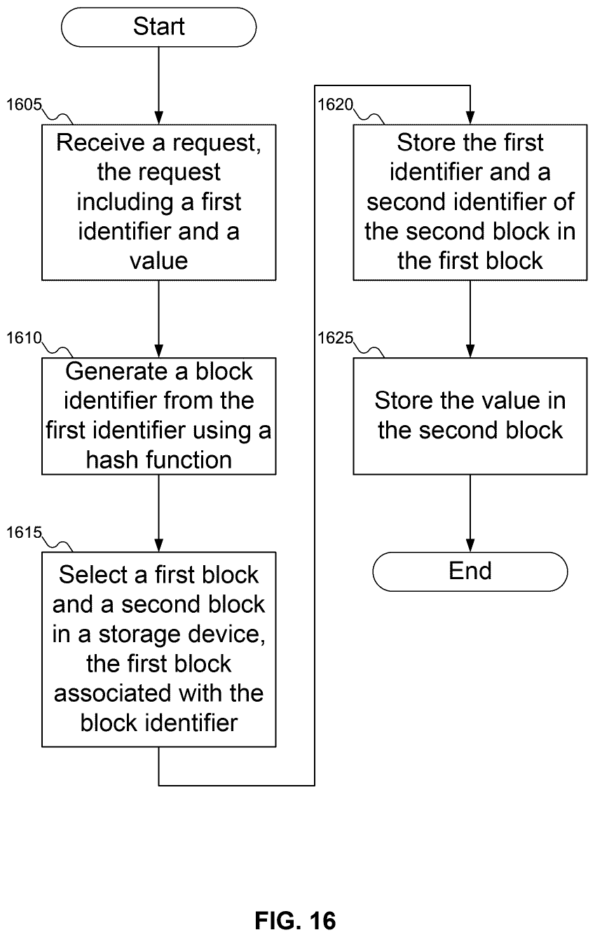

FIG. 16 shows a flowchart of an example procedure for logical block index manager 140 of FIG. 1 to process an I/O request, according to embodiments of the disclosure. In FIG. 16, at block 1605, logical block index manager 140 of FIG. 1 may receive a request. This request may be a request to store data on storage device 120 of FIG. 1: for example, a write request (a block request) or a PUT request (a key-value request). This request may include an identifier, such as a key, and a value. At block 1610, hash function 715 of FIG. 7 may generate a block identifier by hashing the identifier. At block 1615, logical block index manager 140 of FIG. 1 may select blocks on storage device 120 of FIG. 1: one of these blocks may be associated with the block identifier generated by hash function 715 of FIG. 7. Note that in some situations, one of these blocks (which may be referred to as the first block) is the block identified by the block identifier generated by hash function 715 of FIG. 7; in other situations (particularly where there is a hash collision), the first block selected might also be associated with the block identifier generated by hash function 715 of FIG. 7, but might itself be the block identified by the block identifier. For example, if the block identifier generated by hash function 715 of 7 identifies a block that is not currently free (a hash collision), then both the first block and the second block may be blocks with different identifiers than the block identifier generated by hash function 715 of FIG. 7. At block 1620, logical block index manager 140 of FIG. 1 may store the identifier in the first block, along with an identifier of the second block. Finally, at block 1625, logical block index manager 140 of FIG. 1 may store the value in the second block.

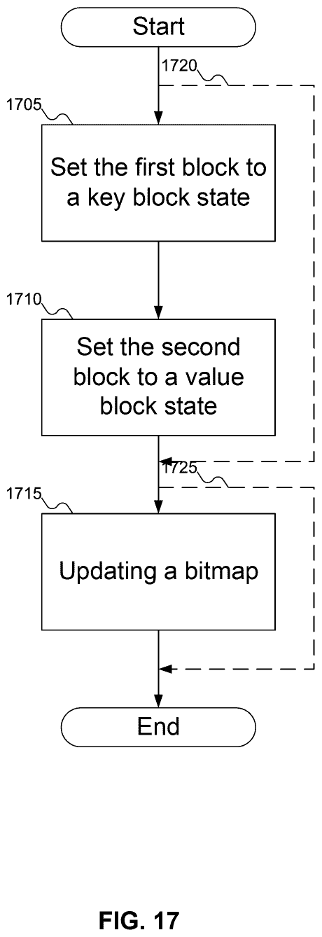

FIG. 17 shows a flowchart of an example procedure for additional processing by logical block index manager 140 of FIG. 1, according to embodiments of the disclosure. In FIG. 17, at block 1705, logical block index manager 140 of FIG. 1 may set the state of the first block to a key block state, and at block 1710, logical block index manager 140 of FIG. 1 may set the state of the second block to a value block state. Then, at block 1715, logical block index manager 140 of FIG. 1 may update bitmap 720 of FIG. 7 to reflect the current state of the blocks. Note that blocks 1705, 1710, and 1715 are variously optional, as shown by dashed lines 1720 and 1725.

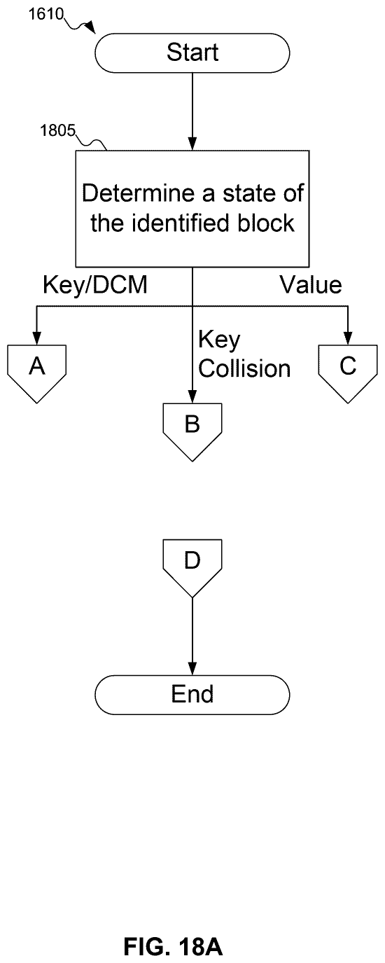

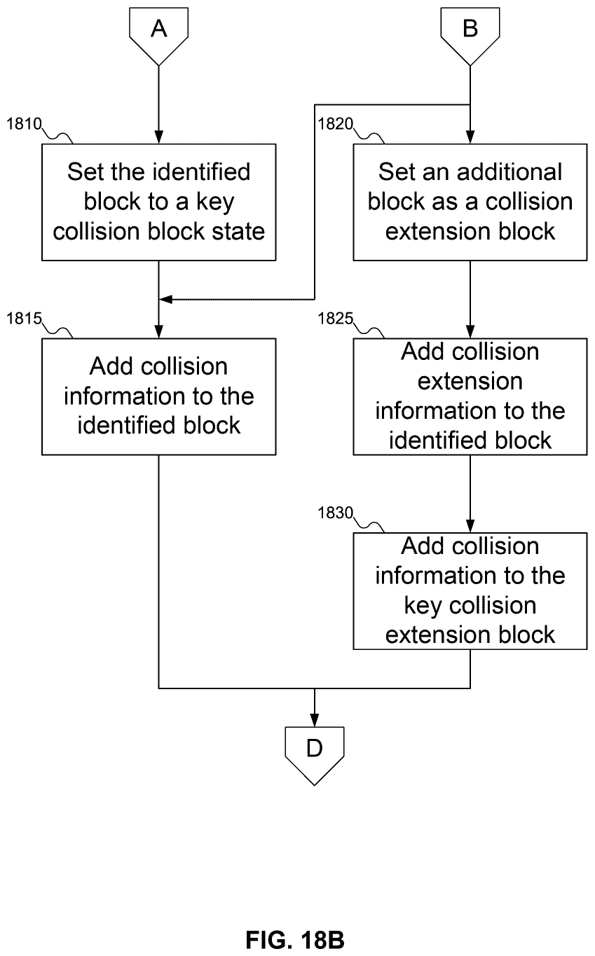

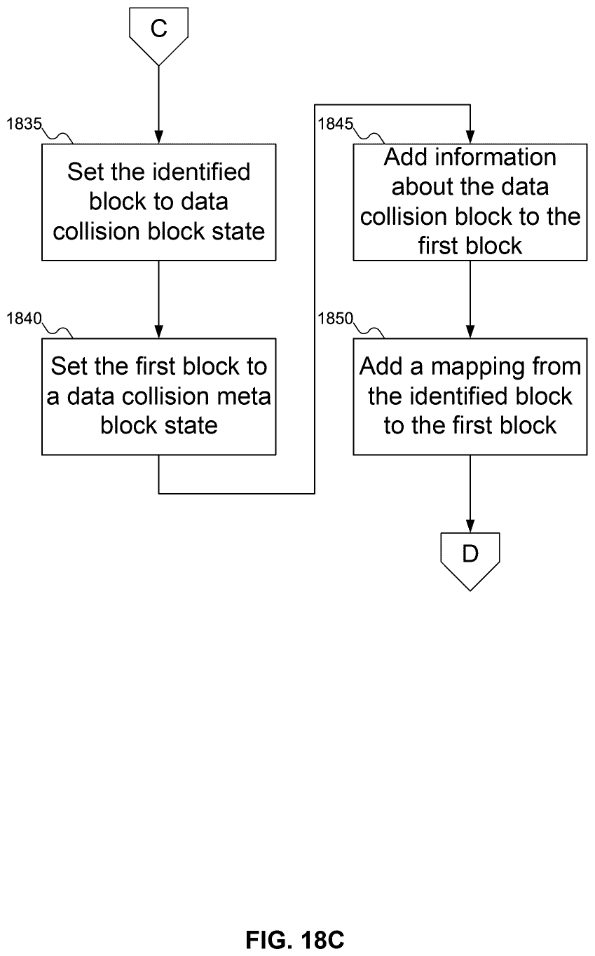

FIGS. 18A-18C show a flowchart of an example procedure for logical block index manager 140 of FIG. 1 to set the state of blocks in storage device 120 of FIG. 1, according to embodiments of the disclosure. In FIG. 18A, at block 1805, logical block index manager 140 of FIG. 1 may determine the state of the first block. It is assumed here that the block identifier generated by hash function 715 of FIG. 7 is not a free block, in which case the state may be set in block 1705 of FIG. 17. In other words, there has been a hash collision of some sort based on the block identifier generated by hash function 715 of FIG. 7.

If the block identifier identifies either a key block or a data collision meta block, then at block 1810 (FIG. 18B), the state of key block 910 of FIG. 9B or the data collision meta block may be updated to a key collision block state. (Note that here, any elsewhere, changes in the state of a block may be updated to bitmap 720 of FIG. 7 as well, whether or not expressly stated. In addition, although not explicitly shown in FIGS. 18A-18C, any block that has its state updated might also be allocated first, if not already available to the application. For example, if the application requested access to a logical volume, the storage associated with that logical volume might already be allocated to the application. Otherwise, one or more blocks may need to be allocated to the application before their state may be updated.) Then, at block 1815, collision entry 925 of FIG. 9C may be added to key collision block 920 of FIG. 9C, after which processing may end.

If the block identifier identifies key collision block 920 of FIG. 9C, then there are two possibilities. If there is room in key collision block 920 of FIG. 9C, processing may continue at block 1815 to add collision entry 925 of FIG. 9C may be added to key collision block 920 of FIG. 9C. Otherwise, key collision block 920 of FIG. 9C does not have room for an addition collision entry 925 of FIG. 9C. Then, at block 1820, the first block may be a key collision extension block, with its state set accordingly. At block 1825, key collision block 920 of FIG. 9C may be updated to include an identifier of or pointer to the key collision extension block, and at block 1830, collision entry 925 of FIG. 9C may then be added to the key collision extension block, after which processing may end.

Finally, if the block identifier identifies value block 905 of FIG. 9A, then at block 1835 (FIG. 18C), the state of value block 905 of FIG. 9A may be changed to a data collision block (which is similar to value block 905 of FIG. 9A except for its state). At block 1840, the first block may be data collision meta block 935 of FIG. 9E, with its state set accordingly. At block 1845, data collision meta block 935 of FIG. 9E may be updated to reference back to the data collision block. Finally, at block 1850, mapping table 730 of FIG. 7 may be updated to include entry 810 of FIG. 8 to map from the block identifier generated by hash function 715 of FIG. 7 to a block identifier for data collision meta block 935 of FIG. 9E, after which processing may end.

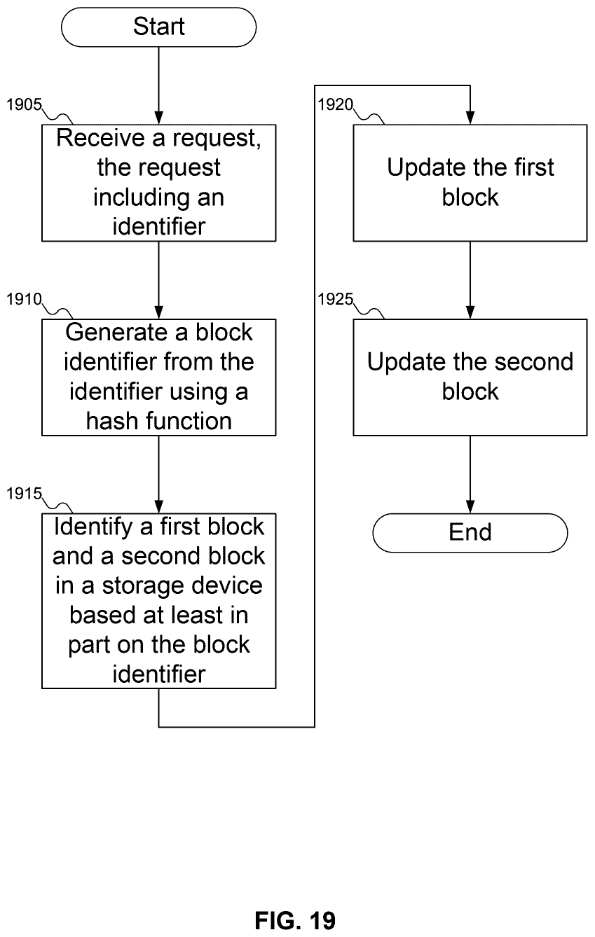

FIG. 19 shows a flowchart of an example procedure for logical block index manager 140 of FIG. 1 to update blocks based on I/O request 410 of FIG. 4, according to embodiments of the disclosure. FIG. 19 may be executed, for example, when I/O request 410 of FIG. 4 is a request to delete the data associated with a particular identifier, such as a key. At block 1905, logical block index manager 140 of FIG. 1 may receive I/O request 410 of FIG. 4. This I/O request 410 of FIG. 4 may include an identifier, such as a logical block address or a key used by the application. At block 1910, hash function 715 of FIG. 7 may generate a block identifier from the identifier in I/O request 410 of FIG. 4. At block 1915, logical block index manager 140 of FIG. 1 may identify two blocks on storage device 120 of FIG. 1. The identification of these blocks may be based on the block identifier generated by hash function 715 of FIG. 7. At block 1920, logical block index manager 140 of FIG. 1 may update the first block, and at block 1925, logical block index manager 140 of FIG. 1 may update the second block. Note that this update may involve changing information stored in the first block and/or the second block, and may also involve updating bitmap 720 of FIG. 7. For example, if I/O request 405 of FIG. 4 is a delete request, then updating the blocks may involve deleting the data in the blocks (although the blocks might still reflect a free block state), as well as updating bitmap 720 of FIG. 7 to reflect that the corresponding blocks are now free.

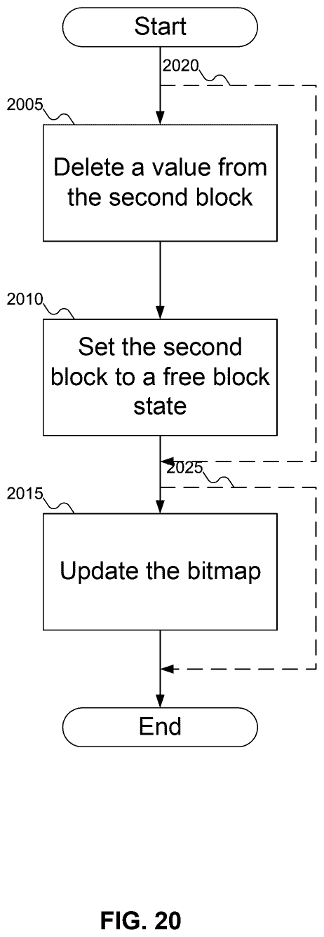

FIG. 20 shows a flowchart of an example procedure for additional processing by logical block index manager 140 of FIG. 1, according to embodiments of the disclosure. In FIG. 20, at block 2005, logical block index manager 140 of FIG. 1 may delete a value from the second block, and at block 2010, logical block index manager 140 of FIG. 1 may set the second block to a free block state. Note that block 2005 may not be necessary, as the data may be effectively deleted by setting the second block to the free block state in block 2010. Finally, at block 2015, logical block index manager 140 of FIG. 1 may update bitmap 720 of FIG. 7 to reflect the changed status for the two blocks. Note that blocks 2005, 2010, and 2015 are variously optional, as shown by dashed lines 2020 and 2025.

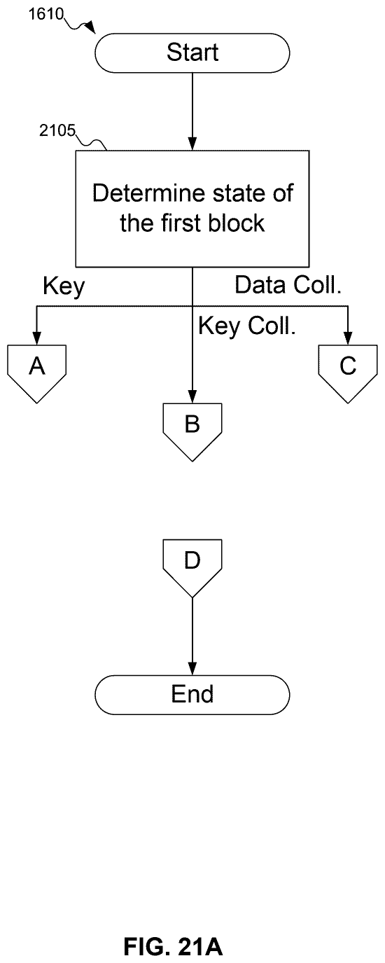

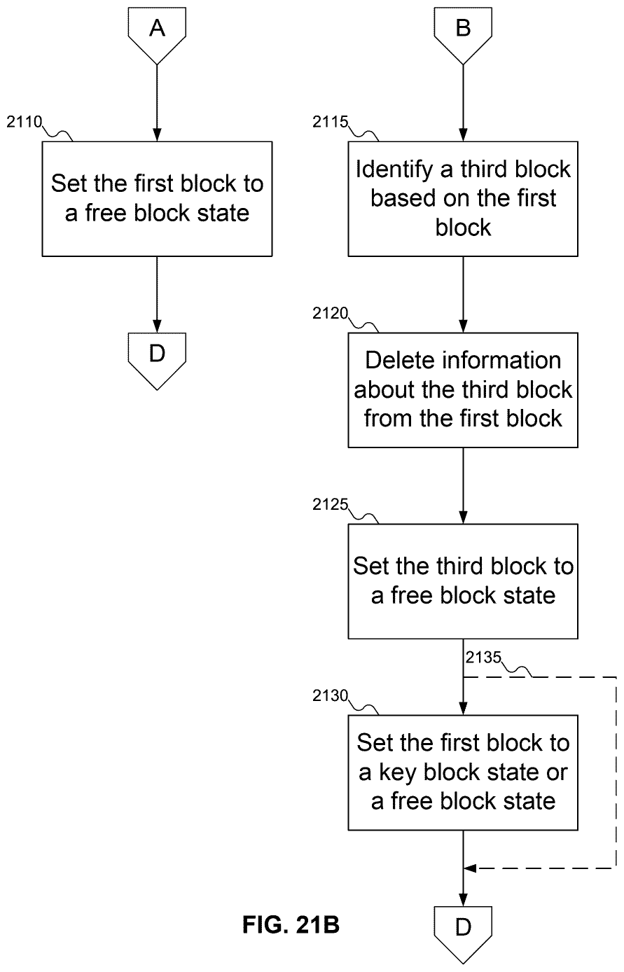

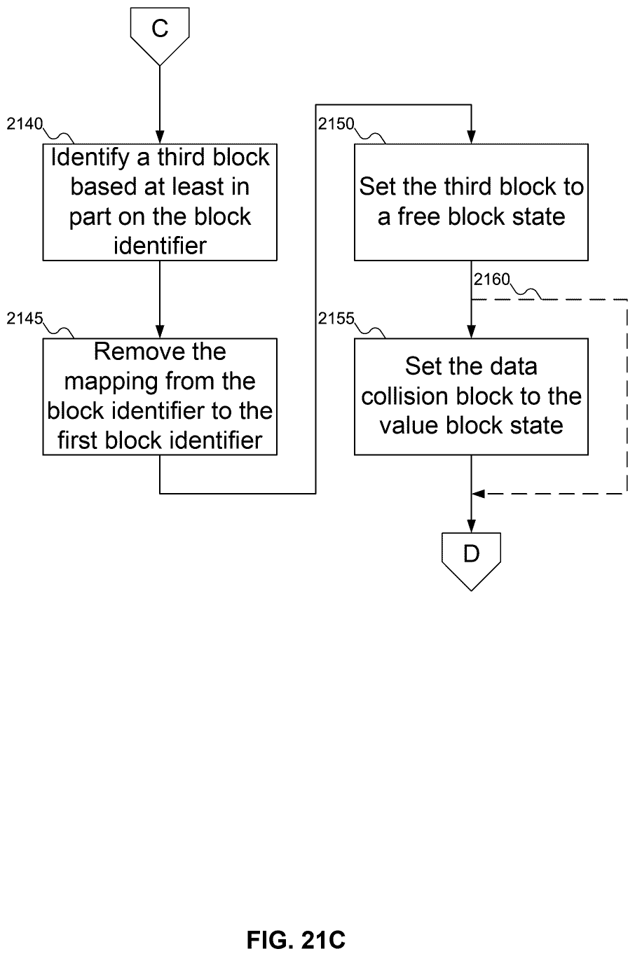

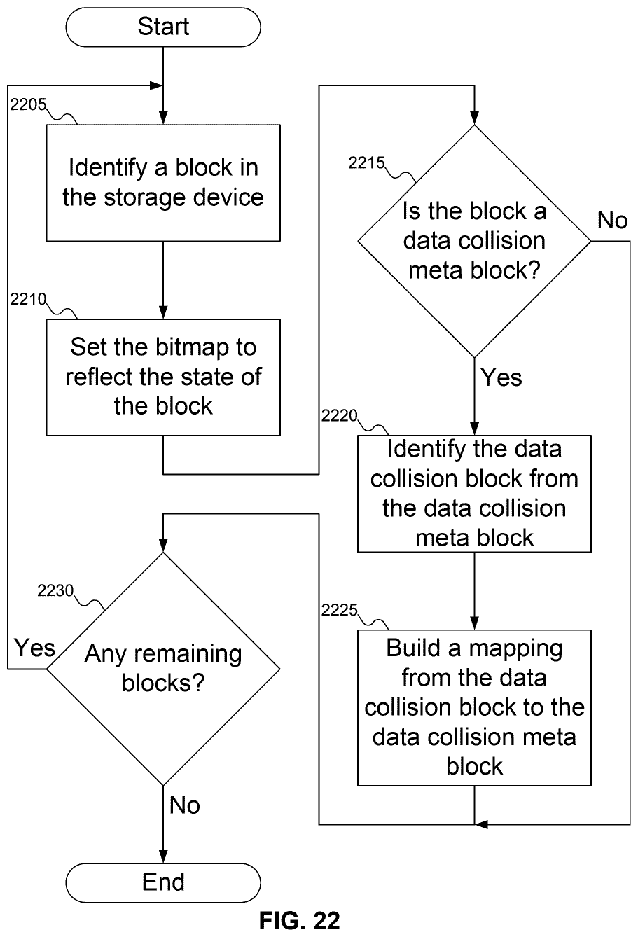

FIGS. 21A-21C show a flowchart of an example procedure for logical block index manager 140 of FIG. 1 to set the state of blocks in storage device 120 of FIG. 1 after I/O request 410 of FIG. 4 as processed in FIG. 19 above, according to embodiments of the disclosure. In FIG. 21A, at block 2105, logical block index manager 140 of FIG. 1 may determine the state of the first block. Since it may be assumed here that an earlier request was already submitted with the identifier of I/O request 410 of FIG. 4, the block identified by the block identifier generated by hash function 715 of FIG. 7 may be assumed to be in a key block state, a key collision block state, or a data collision block state. The block may not be a free block given that the block was accessed previously. Nor may the block be a value block, as the identifiers of value blocks are not generated by hash function 715 of FIG. 7 (if there was an earlier hash collision, then the block would be a data collision block, and not be a value block). For the same reason, the block may not be a data collision meta block. Finally, the block may not be a key collision extension block state, as such a block is an extension of a key collision block, and the block identifier would identify the key collision block instead.

If the first block is a key block, then at block 2110 (FIG. 21B), the state of key block 910 of FIG. 9B or the data collision meta block may be updated to a free block state. (Note that here, any elsewhere, changes in the state of a block may be updated to bitmap 720 of FIG. 7 as well, whether or not expressly stated. In addition, although not explicitly shown in FIGS. 21A-21C, any block that has its state updated might also be deallocated after. For example, if the application requested access to a logical volume, the storage associated with that logical volume might not need to be deallocated until the application has completed using the storage. Otherwise, one or more blocks may be deallocated when the application is finished with those blocks.)

If the block identifier identifies key collision block 920 of FIG. 9C, then at block 2115, a third block may be identified based on the first block. At block 2120, the information about the third block (such as collision entry 925 of FIG. 9C) may be deleted from key collision block 920 of FIG. 9C. At block 2125, the third block may be set to a free block state. Finally, at block 2130, the state of the first block may be updated to either a key block state or a free block state. The first block may be updated to a key block state if the number of collisions in key collision block 920 of FIG. 9C is now zero (indicating there are no remaining hash collisions stored in key collision block 920 of FIG. 9C), and if key collision block 920 of FIG. 9C still stores a valid key itself. The first block may be updated to a free block state if the number of collisions in key collision block 920 of FIG. 9C is now zero (indicating there are no remaining hash collisions stored in key collision block 920 of FIG. 9C), and if key collision block 920 of FIG. 9C does not itself store a valid key. If there is still at least one collision entry 925 of FIG. 9C in key collision block 920 of FIG. 9C, then block 2130 may be omitted, as shown by dashed line 2135.

Finally, if the block identifier identifies a data collision block, then at block 2140 (FIG. 21C), a third block may be identified based on the block identifier. Note that since a data collision block does not include any information about other blocks based on a hash collision (as compared with key collision block 920 of FIG. 9C), the third block may not be identified by accessing collision 925 of FIG. 9C. Instead, mapping table 730 of FIG. 7 may be used to identify the third block, since mapping table 730 of FIG. 7 may map the block identifier to data collection meta block 935 of FIG. 9E. At block 2145, the mapping from the block identifier of data collision block 935 of FIG. 9E to the first block may be removed from mapping table 730 of FIG. 7. At block 2150, the third block may be set to a free block state. Finally, at block 2155, the data collision block may be set to a value block state, assuming that there was only one hash collision involving the data collision block, as may be determined by examining mapping table 730 of FIG. 7. If there are still other hash collisions involving data collision block 935 of FIG. 9E, then block 2155 may be omitted, as shown by dashed line 2160).

FIG. 22 shows a flowchart of an example procedure for rebuilding bitmap 720 of FIG. 7 from storage device 120 of FIG. 1, according to embodiments of the disclosure. This procedure may be useful, for example, if there is a power interruption and bitmap 720 of FIG. 7 is lost. In FIG. 22, at block 2205, logical block index manager 140 of FIG. 1 may identify a block on storage device 120 of FIG. 1. At block 2210, logical block index manager 140 of FIG. 1 may access a state of the block and may set entry 805 of FIG. 8 in bitmap 720 of FIG. 7 to reflect the state of the block. At block 2215, logical block index manager 140 of FIG. 1 may determine whether the state of the block is a data collision meta block state. If so, then at block 2220, logical block index manager 140 of FIG. 1 may identify the data collision block from data collision meta block 935 of FIG. 9E, and at block 2225, logical block index manager 140 of FIG. 1 may update mapping table 730 of FIG. 7 to include entry 810 of FIG. 8, mapping an identifier of the data collision block to data collision meta block 935 of FIG. 9E.

At block 2230, whether the block was data collision meta block 935 of FIG. 9E or not, logical block index manager 140 of FIG. 1 may determine if there are more blocks on storage device 120 of FIG. 1 to examine. If so, the processing may return to block 2205 to examine another block on storage device 120 of FIG. 1; otherwise, processing is complete, and bitmap 720 of FIG. 7 is rebuilt.

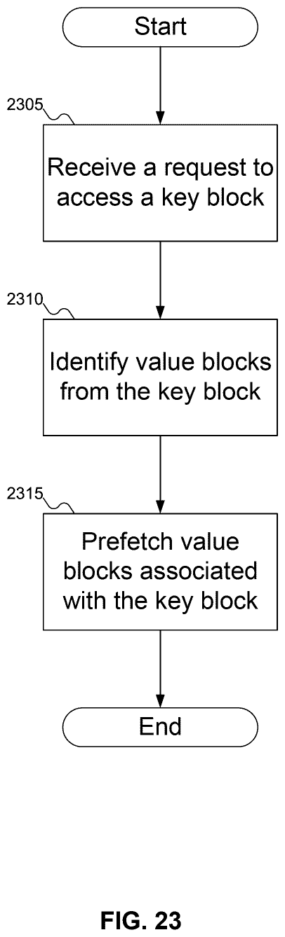

FIG. 23 shows a flowchart of an example procedure for prefetching of blocks from storage device 120 of FIG. 1, according to embodiments of the disclosure. In FIG. 23, at block 2305, logical block index manager 140 of FIG. 1 may receive a request to access data, which may be a request to access data associated with a particular identifier, such as a key. Logical block index manager 140 of FIG. 1 may then access key block 910 of FIG. 9B based on this request. At block 2310, logical block index manager 140 of FIG. 1 may identify value blocks 905 of FIG. 9A that store data associated with the key. Finally, at block 2315, logical block index manager 140 of FIG. 1 may prefetch data from value blocks 905 of FIG. 9A, on the assumption that a request to access some data may imply additional requests for more of the data. The prefetched data may be stored in any desired location: for example, in memory 115 of FIG. 1, in a memory associated with logical block index manager 140 of FIG. 1, a cache somewhere (such as in processor 110 of FIG. 1), or anywhere else desired.

In FIGS. 12-23, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

Embodiments of the disclosure may manage requests to avoid sending requests in an order that might return stale data. A request submission component may check to see if a particular request conflicts with in-flight requests, and if so may delay the request until the conflict is cleared. By avoiding sending requests that conflict to the storage device, embodiments of the disclosure offer a technical advantage to ensure correct data is returned.

Embodiments of the disclosure may include a logical block index manager to manage storage assignment for requests, and in particular for storing key-value data on a block storage device. Using a hash function may reduce the write amplification that may occur when using other data structures, such as a Log-Structured Merge (LSM) tree. By reducing write amplification, embodiments of the disclosure offer a technical advantage to manage where data is stored.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Embodiments of the disclosure may extend to the following statements, without limitation:

Statement 1. An embodiment of the disclosure includes a system, comprising:
a queue, the queue including a request, the request including a first address;
a data structure storing an information associated with a second address; and
a submission component to send the request to a storage device based at least in part on an overlap between the first address and the second address associated with the information in the data structure.

Statement 2. An embodiment of the disclosure includes the system according to statement 1, further comprising a memory, the memory storing the queue.

Statement 3. An embodiment of the disclosure includes the system according to statement 2, wherein the memory further stores the data structure.

Statement 4. An embodiment of the disclosure includes the system according to statement 2, further comprising a second memory, the second memory storing the data structure.

Statement 5. An embodiment of the disclosure includes the system according to statement 1, wherein:
the first address includes a first logical address; and
the second address includes a second logical address.

Statement 6. An embodiment of the disclosure includes the system according to statement 1, wherein:
the first address includes a first address range; and
the second address includes a second address range.

Statement 7. An embodiment of the disclosure includes the system according to statement 1, wherein the data structure includes a radix tree.

Statement 8. An embodiment of the disclosure includes the system according to statement 1, wherein the submission component is configured to send the request to the storage device based at least in part on a lack of overlap between the first address and the second address associated with the information in the data structure.

Statement 9. An embodiment of the disclosure includes the system according to statement 1, wherein the submission component is configured to delay sending the request to the storage device based at least in part on the overlap between the first address and the second address associated with the information in the data structure.

Statement 10. An embodiment of the disclosure includes the system according to statement 1, wherein:
the queue further includes a second request, the second request including a third address; and
the submission component is configured to send the second request to the storage device based at least in part on the overlap between the third address and the second address associated with the information in the data structure.

Statement 11. An embodiment of the disclosure includes the system according to statement 1, wherein:
the queue further includes a second request, the second request including a third address; and
the submission component is configured to delay sending the second request to the storage device based at least in part on the overlap between the first address and the second address associated with the information in the data structure.

Statement 12. An embodiment of the disclosure includes the system according to statement 1, wherein:
the queue further includes a second request, the second request including the second address; and
the submission component is configured to coalesce the first request and the second request.

Statement 13. An embodiment of the disclosure includes the system according to statement 12, wherein the submission component is configured to send the first request and to discard the second request.

Statement 14. An embodiment of the disclosure includes the system according to statement 1, wherein the submission component includes a software executing on a processor.

Statement 15. An embodiment of the disclosure includes the system according to statement 14, wherein the software includes an open source software.

Statement 16. An embodiment of the disclosure includes the system according to statement 1, wherein the system is configured to keep the storage device consistent with a bitmap in a memory of the system.

Statement 17. An embodiment of the disclosure includes the system according to statement 16, wherein the system further comprises a memory associated with a processor, the memory associated with the processor storing the bitmap.

Statement 18. An embodiment of the disclosure includes the system according to statement 1, further comprising a completion component to update the information in the data structure based at least in part on a completion message from the storage device.

Statement 19. An embodiment of the disclosure includes the system according to statement 18, wherein:
the completion message is associated with the second address; and
the completion component is configured to remove the association between the second address and the information in the data structure based at least in part on the completion message.

Statement 20. An embodiment of the disclosure includes the system according to statement 18, wherein:
the completion message is associated with the second address; and the completion component is configured to remove the information from the data structure based at least in part on the completion message.

Statement 21. An embodiment of the disclosure includes the system according to statement 18, wherein the completion component is configured to trigger the submission component based at least in part on the completion message and the queue containing the first request.

Statement 22. An embodiment of the disclosure includes the system according to statement 1, wherein:
the storage device includes a first region and a second region, the first region including the first address and the second address;
the data structure is associated with the first region; and
the system further comprises a second data structure associated with the second region.

Statement 23. An embodiment of the disclosure includes the system according to statement 22, wherein the first region and the second region do not overlap.

Statement 24. An embodiment of the disclosure includes the system according to statement 22, wherein:
the second region includes a third address; and
the second data structure stores a second information associated with a third address.

Statement 25. An embodiment of the disclosure includes the system according to statement 24, wherein:
the queue includes a second request, the second request including a fourth address; and
the submission component is configured to send the second request to the storage device based at least in part on a second overlap between the fourth address and the third address associated with the second information in the second data structure.

Statement 26. An embodiment of the disclosure includes the system according to statement 24, further comprising:
a second queue including a second request, the second request including a fourth address; and
a second submission component to send the second request to the storage device based at least in part on a second overlap between the fourth address and the third address associated with the second information in the second data structure.

Statement 27. An embodiment of the disclosure includes the system according to statement 1, wherein:
the data structure is associated with the storage device; and
the system further comprises:
   a second storage device, the second storage device including a third address; and
   a second data structure associated with the second storage device, the second data structure storing a second information associated with a third address.

Statement 28. An embodiment of the disclosure includes the system according to statement 27, further comprising a second submission component to send a second request to the second storage device based at least in part on a second overlap between a fourth address and the third address associated with the second information in the second data structure, the second request including the fourth address.

Statement 29. An embodiment of the disclosure includes a method, comprising:
accessing a request from a queue, the request including a first address;
accessing a data structure, the data structure including an information associated with a second address;
checking for an overlap between the first address and the second address associated with the information in the data structure; and
sending the request to a storage device based at least in part on the overlap.

Statement 30. An embodiment of the disclosure includes the method according to statement 29, wherein:
the first address includes a first logical address; and
the second address includes a second logical address.

Statement 31. An embodiment of the disclosure includes the method according to statement 29, wherein:
the first address includes a first address range; and
the second address includes a second address range.

Statement 32. An embodiment of the disclosure includes the method according to statement 29, wherein the data structure includes a radix tree.

Statement 33. An embodiment of the disclosure includes the method according to statement 29, wherein checking for the overlap between the first address and the second address associated with the information in the data structure includes determining that there is no overlap between the first address and the second address associated with the information in the data structure.

Statement 34. An embodiment of the disclosure includes the method according to statement 29, wherein:
checking for the overlap between the first address and the second address associated with the information in the data structure includes determining that there is an overlap between the first address and the second address associated with the information in the data structure; and
sending the request to the storage device based at least in part on the overlap includes delaying the sending of the request to the storage device based at least in part on the overlap between the first address and the second address associated with the information in the data structure being present.

Statement 35. An embodiment of the disclosure includes the method according to statement 34, wherein delaying the sending of the request to the storage device based at least in part on the overlap between the first address and the second address associated with the information in the data structure being present includes delaying the sending of the request to the storage device based at least in part on a completion message is received from the storage device, the completion message associated with the second address.

Statement 36. An embodiment of the disclosure includes the method according to statement 29, further comprising:
accessing a second request from the queue, the second request including a third address;
checking for a second overlap between the third address and the second address associated with the information in the data structure; and
sending the request to a storage device based at least in part on the second overlap.

Statement 37. An embodiment of the disclosure includes the method according to statement 29, further comprising:
accessing a second request from the queue, the second request including a third address;
delaying the sending of the second request to the storage device based at least in part on the overlap.

Statement 38. An embodiment of the disclosure includes the method according to statement 29, further comprising:
accessing a second request from the queue, the second request including the first address; and
coalescing the first request and the second request.

Statement 39. An embodiment of the disclosure includes the method according to statement 29, further comprising:
receiving a completion message from the storage device; and
updating the data structure based at least in part on the completion message.

Statement 40. An embodiment of the disclosure includes the method according to statement 39, wherein:
the completion message is associated with the second address; and
updating the data structure based at least in part on the completion message includes removing the association between the second address and the information in the data structure based at least in part on the completion message.

Statement 41. An embodiment of the disclosure includes the method according to statement 39, wherein:
the completion message is associated with the second address; and
updating the data structure based at least in part on the completion message includes removing the information from the data structure based at least in part on the completion message.

Statement 42. An embodiment of the disclosure includes the method according to statement 39, further comprising performing the operations of accessing the request from the queue, checking for the overlap, and sending the request to the storage device based at least in part on receiving the completion message.

Statement 43. An embodiment of the disclosure includes the method according to statement 29, wherein:
the storage device includes a first region and a second region, the first region including the first address and the second address;
the data structure is associated with the first region; and
checkin for the overlap between the first address and the second address associated with the information in the data structure includes checking for the overlap between the first address and the second address associated with the information in the data structure based at least in part on the first address being in the first region.

Statement 44. An embodiment of the disclosure includes the method according to statement 43, wherein the first region and the second region do not overlap.

Statement 45. An embodiment of the disclosure includes the method according to statement 43, further comprising:
the second region includes a third address and a fourth address;
accessing a second request from the queue, the request including the third address;
accessing a second data structure, the second data structure including a second information associated with the fourth address; and
checking for a second overlap between the third address and the fourth address associated with the second information in the second data structure; and
sending the second request to the storage device based at least in part on the second overlap.

Statement 46. An embodiment of the disclosure includes the method according to statement 43, further comprising:
the second region includes a third address and a fourth address;
accessing a second request from a second queue, the request including the third address;
accessing a second data structure, the second data structure including a second information associated with the fourth address; and
checking for a second overlap between the third address and the fourth address associated with the second information in the second data structure; and
sending the second request to the storage device based at least in part on the second overlap.

Statement 47. An embodiment of the disclosure includes the method according to statement 29, wherein:
the storage device is associated with the first address and the second address; and
the method further comprises:
   accessing a second request from a second queue, the request including a third address;
   accessing a second data structure, the second data structure including a second information associated with a fourth address; and
   checking for a second overlap between the third address and the fourth address associated with the second information in the second data structure; and
   sending the second request to a second storage device based at least in part on the second overlap, the second storage device associated with the third address and the fourth address.

Statement 48. An embodiment of the disclosure includes a system, comprising a non-transitory storage medium, the non-transitory storage medium having stored thereon instructions that, when executed by a machine, result in:
accessing a request from a queue, the request including a first address;
accessing a data structure, the data structure including an information associated with a second address;
checking for an overlap between the first address and the second address associated with the information in the data structure; and
sending the request to a storage device based at least in part on the overlap.

Statement 49. An embodiment of the disclosure includes the system according to statement 48, wherein:
the first address includes a first logical address; and
the second address includes a second logical address.

Statement 50. An embodiment of the disclosure includes the system according to statement 48, wherein:
the first address includes a first address range; and
the second address includes a second address range.

Statement 51. An embodiment of the disclosure includes the system according to statement 48, wherein the data structure includes a radix tree.

Statement 52. An embodiment of the disclosure includes the system according to statement 48, wherein checking for the overlap between the first address and the second address associated with the information in the data structure includes determining that there is no overlap between the first address and the second address associated with the information in the data structure.

Statement 53. An embodiment of the disclosure includes the system according to statement 48, wherein:
checking for the overlap between the first address and the second address associated with the information in the data structure includes determining that there is an overlap between the first address and the second address associated with the information in the data structure; and
sending the request to the storage device based at least in part on the overlap includes delaying the sending of the request to the storage device based at least in part on the overlap between the first address and the second address associated with the information in the data structure being present.

Statement 54. An embodiment of the disclosure includes the system according to statement 53, wherein delaying the sending of the request to the storage device based at least in part on the overlap between the first address and the second address associated with the information in the data structure being present includes delaying the sending of the request to the storage device based at least in part on a completion message is received from the storage device, the completion message associated with the second address.

Statement 55. An embodiment of the disclosure includes the system according to statement 48, the non-transitory storage medium having stored thereon further instructions that, when executed by the machine, result in:
accessing a second request from the queue, the second request including a third address;
checking for a second overlap between the third address and the second address associated with the information in the data structure; and
sending the request to a storage device based at least in part on the second overlap.

Statement 56. An embodiment of the disclosure includes the system according to statement 48, the non-transitory storage medium having stored thereon further instructions that, when executed by the machine, result in:
accessing a second request from the queue, the second request including a third address;
delaying the sending of the second request to the storage device based at least in part on the overlap.

Statement 57. An embodiment of the disclosure includes the system according to statement 48, the non-transitory storage medium having stored thereon further instructions that, when executed by the machine, result in:
accessing a second request from the queue, the second request including the first address; and
coalescing the first request and the second request.

Statement 58. An embodiment of the disclosure includes the system according to statement 48, the non-transitory storage medium having stored thereon further instructions that, when executed by the machine, result in:
receiving a completion message from the storage device; and
updating the data structure based at least in part on the completion message.

Statement 59. An embodiment of the disclosure includes the system according to statement 58, wherein:
the completion message is associated with the second address; and
updating the data structure based at least in part on the completion message includes removing the association between the second address and the information in the data structure based at least in part on the completion message.

Statement 60. An embodiment of the disclosure includes the system according to statement 58, wherein:
the completion message is associated with the second address; and
updating the data structure based at least in part on the completion message includes removing the information from the data structure based at least in part on the completion message.

Statement 61. An embodiment of the disclosure includes the system according to statement 58, the non-transitory storage medium having stored thereon further instructions that, when executed by the machine, result in performing the operations of accessing the request from the queue, checking for the overlap, and sending the request to the storage device based at least in part on receiving the completion message.

Statement 62. An embodiment of the disclosure includes the system according to statement 48, wherein:
the storage device includes a first region and a second region, the first region including the first address and the second address;
the data structure is associated with the first region; and
checking for the overlap between the first address and the second address associated with the information in the data structure includes checking for the overlap between the first address and the second address associated with the information in the data structure based at least in part on the first address being in the first region.

Statement 63. An embodiment of the disclosure includes the system according to statement 62, wherein the first region and the second region do not overlap.

Statement 64. An embodiment of the disclosure includes the system according to statement 62, the non-transitory storage medium having stored thereon further instructions that, when executed by the machine, result in:
the second region includes a third address and a fourth address;
accessing a second request from the queue, the request including the third address;
accessing a second data structure, the second data structure including a second information associated with the fourth address; and
checking for a second overlap between the third address and the fourth address associated with the second information in the second data structure; and
sending the second request to the storage device based at least in part on the second overlap.

Statement 65. An embodiment of the disclosure includes the system according to statement 62, the non-transitory storage medium having stored thereon further instructions that, when executed by the machine, result in:
the second region includes a third address and a fourth address;
accessing a second request from a second queue, the request including the third address;
accessing a second data structure, the second data structure including a second information associated with the fourth address; and
checking for a second overlap between the third address and the fourth address associated with the second information in the second data structure; and
sending the second request to the storage device based at least in part on the second overlap.

Statement 66. An embodiment of the disclosure includes the system according to statement 48, wherein:
the storage device is associated with the first address and the second address; and
the non-transitory storage medium has stored thereon further instructions that, when executed by the machine, result in:
   accessing a second request from a second queue, the request including a third address;
   accessing a second data structure, the second data structure including a second information associated with a fourth address; and
   checking for a second overlap between the third address and the fourth address associated with the second information in the second data structure; and
   sending the second request to a second storage device based at least in part on the second overlap, the second storage device associated with the third address and the fourth address.

Statement 67. An embodiment of the disclosure includes a system, comprising:
a receiver to receive a request, the request including an identifier;
a hash function to generate a block identifier based at least in part on the identifier;
a bitmap to store a first state of a first block and a second state of a second block;
a block request generator to generate a block request based at least in part on the request and the block identifier, the block request including at least one of the first block or the second block;
a storage device, the storage device including the first block and the second block, the storage device configured to process the block request.

Statement 68. An embodiment of the disclosure includes the system according to statement 67, wherein the receiver is configured to receive a key-value request, the key-value request including a key, the key including the identifier.

Statement 69. An embodiment of the disclosure includes the system according to statement 67, wherein:
the first state of the first block is drawn from a set including a free block state, a key block state, a key collision block state, a key collision extension block state, a value block state, a data collision block state, or a data collision meta block state; and
the second state of the second block is drawn from the set including the free block state, the key block state, the key collision block state, the key collision extension block state, the value block state, the data collision block state, or the data collision meta block state.

Statement 70. An embodiment of the disclosure includes the system according to claim 67, further comprising a state machine to manage a transition of the first block from the first state to a third state.

Statement 71. An embodiment of the disclosure includes the system according to statement 67, further comprising a mapping table associating the block identifier with a second block identifier.

Statement 72. An embodiment of the disclosure includes the system according to statement 67, wherein:
the first block stores a first information about the identifier; and the second block stores a second information about a value, the value associated with the identifier.

Statement 73. An embodiment of the disclosure includes the system according to statement 67, wherein the first block and the second block are adjacent.

Statement 74. An embodiment of the disclosure includes the system according to statement 67, wherein the storage device is configured to allocate the first block and the second block.

Statement 75. An embodiment of the disclosure includes the system according to statement 74, wherein the storage device is configured to allocate the first block and the second block together.

Statement 76. An embodiment of the disclosure includes a method, comprising:
receiving a request, the request including a first identifier and a value;
generating a block identifier from the first identifier using a hash function;
selecting a first block and a second block in a storage device, the first block associated with the block identifier;
storing the first identifier and a second identifier of the second block in the first block; and
storing the value in the second block.

Statement 77. An embodiment of the disclosure includes the method according to statement 76, wherein receiving the request includes receiving a key-value request, the key-value request including a key, the key including the first identifier.

Statement 78. An embodiment of the disclosure includes the method according to statement 76, wherein storing the first identifier and the second identifier of the second block in the first block includes storing the first identifier and a pointer to the second block in the first block.

Statement 79. An embodiment of the disclosure includes the method according to statement 76, further comprising updating a bitmap identifying a first state of the first block and a second state of the second block.

Statement 80. An embodiment of the disclosure includes the method according to statement 79, wherein:
the first state of the first block is drawn from a set including a free block state, a key block state, a key collision block state, a key collision extension block state, a value block state, a data collision block state, or a data collision meta block state; and
the second state of the second block is drawn from the set including the free block state, the key block state, the key collision block state, the key collision extension block state, the value block state, the data collision block state, or the data collision meta block state.

Statement 81. An embodiment of the disclosure includes the method according to statement 76, further comprising:
setting the first block to a key block state; and
setting the second block to a value block state.

Statement 82. An embodiment of the disclosure includes the method according to statement 81, wherein:
setting the first block to the key block state includes setting the first block to a key block state using a state machine; and
setting the second block to the value block state includes setting the second block to a value block state by the state machine.

Statement 83. An embodiment of the disclosure includes the method according to statement 76, wherein selecting the first block and the second block in the storage device includes selecting the first block and the second block in the storage device based at least in part on a size of the value.

Statement 84. An embodiment of the disclosure includes the method according to statement 83, wherein selecting the first block and the second block in the storage device based at least in part on the size of the value includes selecting a third block in the storage device.

Statement 85. An embodiment of the disclosure includes the method according to statement 84, wherein the second block and the third block are adjacent.

Statement 86. An embodiment of the disclosure includes the method according to statement 76, wherein the first block and the second block are adjacent.

Statement 87. An embodiment of the disclosure includes the method according to statement 76, wherein generating the block identifier from the first identifier using the hash function includes determining that the first block is in a free block state.

Statement 88. An embodiment of the disclosure includes the method according to statement 76, wherein generating the block identifier from the first identifier using the hash function includes:
determining that the block identifier identifies a third block; and
determining that the third block is in a key block state or a key collision block state.

Statement 89. An embodiment of the disclosure includes the method according to statement 88, further comprising updating the third block to include a third identifier of the first block.

Statement 90. An embodiment of the disclosure includes the method according to statement 89, wherein updating the third block to include the third identifier of the first block includes updating the third block to include the third identifier of the first block by a state machine.

Statement 91. An embodiment of the disclosure includes the method according to statement 89, further comprising setting the third block to a key collision block state.

Statement 92. An embodiment of the disclosure includes the method according to statement 89, wherein setting the third block to the key collision block state includes setting the third block to the key collision block state by a state machine.

Statement 93. An embodiment of the disclosure includes the method according to statement 89, wherein updating the third block to include the third identifier of the first block includes updating the third block to include a pointer to the first block.

Statement 94. An embodiment of the disclosure includes the method according to statement 88, further comprising setting the first block to a key collision extension block state. Statement 95. An embodiment of the disclosure includes the method according to statement 94, wherein setting the first block to the key collision extension block state includes setting the first block to the key collision extension block state by a state machine.

Statement 96. An embodiment of the disclosure includes the method according to statement 76, wherein generating the block identifier from the first identifier using the hash function includes:
determining that the block identifier identifies a third block; and
determining that the third block is in a value block state.

Statement 97. An embodiment of the disclosure includes the method according to statement 96, further comprising setting the third block to a data collision block state.

Statement 98. An embodiment of the disclosure includes the method according to statement 97, wherein setting the third block to the data collision block state includes setting the third block to the data collision block state by a state machine.

Statement 99. An embodiment of the disclosure includes the method according to statement 96, further comprising setting the first block to a data collision meta block state.

Statement 100. An embodiment of the disclosure includes the method according to statement 99, wherein setting the first block to the data collision meta block state includes setting the first block to the data collision meta block state by a state machine.

Statement 101. An embodiment of the disclosure includes the method according to statement 96, further comprising mapping the block identifier to a second block identifier, the second block identifier identifying the first block.

Statement 102. An embodiment of the disclosure includes a method, comprising:
receiving a request, the request including an identifier;
generating a block identifier from the identifier using a hash function;
identifying a first block and a second block in a storage device based at least in part on the block identifier;
updating the first block; and
updating the second block.

Statement 103. An embodiment of the disclosure includes the method according to statement 102, wherein receiving the request includes receiving a key-value request, the key-value request including a key, the key including the first identifier.

Statement 104. An embodiment of the disclosure includes the method according to statement 102, wherein identifying the first block and the second block in the storage device based at least in part on the block identifier includes:
identifying the first block based at least in part on the block identifier; and
identifying the second block based at least in part on a second identifier in the first block.

Statement 105. An embodiment of the disclosure includes the method according to statement 104, wherein identifying the second block based at least in part on the second identifier in the first block includes identifying the second block based at least in part on a pointer in the first block.

Statement 106. An embodiment of the disclosure includes the method according to statement 102, further comprising updating a bitmap identifying a first state of the first block and a second state of the second block.

Statement 107. An embodiment of the disclosure includes the method according to statement 106, wherein:
the first state of the first block is drawn from a set including a free block state, a key block state, a key collision block state, a key collision extension block state, a value block state, a data collision block state, or a data collision meta block state; and
the second state of the second block is drawn from the set including the free block state, the key block state, the key collision block state, the key collision extension block state, the value block state, the data collision block state, or the data collision meta block state.

Statement 108. An embodiment of the disclosure includes the method according to statement 102, wherein updating the first block includes:
determining that the first block is in a key block state; and
setting the first block to a free block state.

Statement 109. An embodiment of the disclosure includes the method according to statement 108, wherein setting the first block to the free block state includes setting the first block to the free block state by a state machine.

Statement 110. An embodiment of the disclosure includes the method according to statement 102, wherein updating the first block includes:
determining that the first block is in a data collision block state;
identifying a third block based at least in part on the block identifier; and
setting the third block to a free block state.

Statement 111. An embodiment of the disclosure includes the method according to statement 110, wherein setting the third block to the free block state includes setting the third block to the free block state by a state machine.

Statement 112. An embodiment of the disclosure includes the method according to statement 110, wherein updating the first block further includes removing a mapping from the block identifier to a second block identifier, the block identifier identifying a third block, the second block identifier identifying the first block.

Statement 113. An embodiment of the disclosure includes the method according to statement 110, wherein updating the first block further includes setting the first block to a value block state.

Statement 114. An embodiment of the disclosure includes the method according to statement 113, wherein setting the first block to the value block state includes setting the first block to the value block state by a state machine.

Statement 115. An embodiment of the disclosure includes the method according to statement 102, wherein updating the first block includes:
determining that the first block is in a key collision block state or a key collision extension block state;
identifying a third block based at least in part on the first block; and deleting information about the third block from the first block.

Statement 116. An embodiment of the disclosure includes the method according to statement 115, wherein updating the first block further includes setting the third block to a free block state.

Statement 117. An embodiment of the disclosure includes the method according to statement 116, wherein setting the third block to the free block state includes setting the third block to the free block state by a state machine.

Statement 118. An embodiment of the disclosure includes the method according to statement 115, wherein updating the first block further includes setting the first block to a key block state or a free block state.

Statement 119. An embodiment of the disclosure includes the method according to statement 118, wherein setting the first block to the key block state or the free block state includes setting the first block to the key block state or the free block state by a state machine.

Statement 120. An embodiment of the disclosure includes the method according to statement 102, wherein updating the second block includes setting the second block to a free block state.

Statement 121. An embodiment of the disclosure includes the method according to statement 120, wherein setting the second block to the free block state includes setting the second block to the free block state by a state machine (725).

Statement 122. An embodiment of the disclosure includes the method according to statement 120, wherein updating the second block further includes deleting a value from the second block.

Statement 123. An embodiment of the disclosure includes the method according to statement 102, wherein updating the second block includes updating the second block based at least in part on a size of a value associated with the identifier.

Statement 124. An embodiment of the disclosure includes the method according to statement 123, wherein updating the second block based at least in part on the size of the value associated with the identifier includes updating a third block in the storage device.

Statement 125. An embodiment of the disclosure includes the method according to statement 124, wherein the second block and the third block are adjacent.

Statement 126. An embodiment of the disclosure includes the method according to statement 102, wherein the first block and the second block are adjacent.

Statement 127. An embodiment of the disclosure includes a method, comprising:
identifying a block in a storage device;
accessing a state of the block; and
setting an entry in the bitmap to reflect the state of the block.

Statement 128.An embodiment of the disclosure includes the method according to statement 127, further comprising repeating the operations of identifying the block, accessing the state of the block, and setting the entry in the bitmap for a second block in the storage device.

Statement 129. An embodiment of the disclosure includes the method according to statement 127, wherein setting the entry in the bitmap includes:
determining that the state of the block is a data collision meta block;
identifying a data collision block from the data collision meta block; and
mapping a first identifier of the data collision block to a second identifier of the data collision meta block.

Statement 130. An embodiment of the disclosure includes the method according to statement 129, wherein mapping a first identifier of the data collision block to a second identifier of the data collision meta block includes adding an entry to a mapping table to map the first identifier to the second identifier.

Statement 131. An embodiment of the disclosure includes a method, comprising:
receiving a request to access a key block on a storage device;
accessing a key from the key block on the storage device; and
prefetching a data from a value block on the storage device.

Statement 132. An embodiment of the disclosure includes the method according to statement 131, wherein prefetching the second data from the value block on the storage device includes identifying the value block from the key block.

Statement 133. An embodiment of the disclosure includes the method according to statement 132, wherein identifying the value block from the key block includes identifying the value block based at least in part on a data entry in the key block.

Statement 134. An embodiment of the disclosure includes the method according to statement 131, further comprising prefetching a second data from a second value block on the storage device.

Statement 135. An embodiment of the disclosure includes a system, comprising a non-transitory storage medium, the non-transitory storage medium having stored thereon instructions that, when executed by a machine, result in:
receiving a request, the request including a first identifier and a value;
generating a block identifier from the first identifier using a hash function;
selecting a first block and a second block in a storage device, the first block associated with the block identifier;
storing the first identifier and a second identifier of the second block in the first block; and
storing the value in the second block.

Statement 136. An embodiment of the disclosure includes the system according to statement 135, wherein receiving the request includes receiving a key-value request, the key-value request including a key, the key including the first identifier.

Statement 137. An embodiment of the disclosure includes the system according to statement 135, wherein storing the first identifier and the second identifier of the second block in the first block includes storing the first identifier and a pointer to the second block in the first block.

Statement 138. An embodiment of the disclosure includes the system according to statement 135, the non-transitory storage medium having stored thereon further instructions that, when executed by the machine, result in updating a bitmap identifying a first state of the first block and a second state of the second block.

Statement 139. An embodiment of the disclosure includes the system according to statement 138, wherein:
the first state of the first block is drawn from a set including a free block state, a key block state, a key collision block state, a key collision extension block state, a value block state, a data collision block state, or a data collision meta block state; and
the second state of the second block is drawn from the set including the free block state, the key block state, the key collision block state, the key collision extension block state, the value block state, the data collision block state, or the data collision meta block state.

Statement 140. An embodiment of the disclosure includes the system according to statement 135, the non-transitory storage medium having stored thereon further instructions that, when executed by the machine, result in:
setting the first block to a key block state; and
setting the second block to a value block state.

Statement 141. An embodiment of the disclosure includes the system according to statement 142, wherein:
setting the first block to the key block state includes setting the first block to a key block state using a state machine; and
setting the second block to the value block state includes setting the second block to a value block state by the state machine.

Statement 142. An embodiment of the disclosure includes the system according to statement 135, wherein selecting the first block and the second block in the storage device includes selecting the first block and the second block in the storage device based at least in part on a size of the value.

Statement 143. An embodiment of the disclosure includes the system according to statement 142, wherein selecting the first block and the second block in the storage device based at least in part on the size of the value includes selecting a third block in the storage device.

Statement 144. An embodiment of the disclosure includes the system according to statement 143, wherein the second block and the third block are adjacent.

Statement 145. An embodiment of the disclosure includes the system according to statement 135, wherein the first block and the second block are adjacent.

Statement 146. An embodiment of the disclosure includes the system according to statement 135, wherein generating the block identifier from the first identifier using the hash function includes:
determining that the first block is in a free block state.

Statement 147. An embodiment of the disclosure includes the system according to statement 135, wherein generating the block identifier from the first identifier using the hash function includes:
determining that the block identifier identifies a third block; and
determining that the third block is in a key block state or a key collision block state.

Statement 148. An embodiment of the disclosure includes the system according to statement 147, the non-transitory storage medium having stored thereon further instructions that, when executed by the machine, result in updating the third block to include a third identifier of the first block.

Statement 149. An embodiment of the disclosure includes the system according to statement 148, wherein updating the third block to include the third identifier of the first block includes updating the third block to include the third identifier of the first block by a state machine.

Statement 150. An embodiment of the disclosure includes the system according to statement 148, the non-transitory storage medium having stored thereon further instructions that, when executed by the machine, result in setting the third block to a key collision block state.

Statement 151. An embodiment of the disclosure includes the system according to statement 150, wherein setting the third block to the key collision block state includes setting the third block to the key collision block state by a state machine.

Statement 152. An embodiment of the disclosure includes the system according to statement 148, wherein updating the third block to include the third identifier of the first block includes updating the third block to include a pointer to the first block.

Statement 153. An embodiment of the disclosure includes the system according to statement 147, the non-transitory storage medium having stored thereon further instructions that, when executed by the machine, result in setting the first block to a key collision extension block state.

Statement 154. An embodiment of the disclosure includes the system according to statement 153, wherein setting the first block to the key collision extension block state includes setting the first block to the key collision extension block state by a state machine.

Statement 155. An embodiment of the disclosure includes the system according to statement 135, wherein generating the block identifier from the first identifier using the hash function includes:
determining that the block identifier identifies a third block; and
determining that the third block is in a value block state.

Statement 156. An embodiment of the disclosure includes the system according to statement 155, the non-transitory storage medium having stored thereon further instructions that, when executed by the machine, result in setting the third block to a data collision block state.

Statement 157. An embodiment of the disclosure includes the system according to statement 156, wherein setting the third block to the data collision block state includes setting the third block to the data collision block state by a state machine.

Statement 158. An embodiment of the disclosure includes the system according to statement 155, the non-transitory storage medium having stored thereon further instructions that, when executed by the machine, result in setting the first block to a data collision meta block state.

Statement 159. An embodiment of the disclosure includes the system according to statement 158, wherein setting the first block to the data collision meta block state includes setting the first block to the data collision meta block state by a state machine.

Statement 160. An embodiment of the disclosure includes the system according to statement 155, the non-transitory storage medium having stored thereon further instructions that, when executed by the machine, result in mapping the block identifier to a second block identifier, the second block identifier identifying the first block.

Statement 161. An embodiment of the disclosure includes a system, comprising a non-transitory storage medium, the non-transitory storage medium having stored thereon instructions that, when executed by a machine, result in:
receiving a request, the request including an identifier;
generating a block identifier from the identifier using a hash function;
identifying a first block and a second block in a storage device based at least in part on the block identifier;
updating the first block; and
updating the second block.

Statement 162. An embodiment of the disclosure includes the system according to statement 161, wherein receiving the request includes receiving a key-value request, the key-value request including a key, the key including the first identifier.

Statement 163. An embodiment of the disclosure includes the system according to statement 161, wherein identifying the first block and the second block in the storage device based at least in part on the block identifier includes:
identifying the first block based at least in part on the block identifier; and
identifying the second block based at least in part on a second identifier in the first block.

Statement 164. An embodiment of the disclosure includes the system according to statement 163, wherein identifying the second block based at least in part on the second identifier in the first block includes identifying the second block based at least in part on a pointer in the first block.

Statement 165. An embodiment of the disclosure includes the system according to statement 161, the non-transitory storage medium having stored thereon further instructions that, when executed by the machine, result in updating a bitmap identifying a first state of the first block and a second state of the second block.

Statement 166. An embodiment of the disclosure includes the system according to statement 165, wherein:
the first state of the first block is drawn from a set including a free block state, a key block state, a key collision block state, a key collision extension block state, a value block state, a data collision block state, or a data collision meta block state; and
the second state of the second block is drawn from the set including the free block state, the key block state, the key collision block state, the key collision extension block state, the value block state, the data collision block state, or the data collision meta block state.

Statement 167. An embodiment of the disclosure includes the system according to statement 161, wherein updating the first block includes:
determining that the first block is in a key block state; and
setting the first block to a free block state.

Statement 168. An embodiment of the disclosure includes the system according to statement 167, wherein setting the first block to the free block state includes setting the first block to the free block state by a state machine.

Statement 169. An embodiment of the disclosure includes the system according to statement 161, wherein updating the first block includes:
determining that the first block is in a data collision block state;
identifying a third block based at least in part on the block identifier; and
setting the third block to a free block state.

Statement 170. An embodiment of the disclosure includes the system according to statement 169, wherein setting the third block to the free block state includes setting the third block to the free block state by a state machine.

Statement 171. An embodiment of the disclosure includes the system according to statement 169, wherein updating the first block further includes removing a mapping from the block identifier to a second block identifier, the block identifier identifying a third block, the second block identifier identifying the first block.

Statement 172. An embodiment of the disclosure includes the system according to statement 169, wherein updating the first block further includes setting the first block to a value block state.

Statement 173. An embodiment of the disclosure includes the system according to statement 172, wherein setting the first block to the value block state includes setting the first block to the value block state by a state machine.

Statement 174. An embodiment of the disclosure includes the system according to statement 161, wherein updating the first block includes:
determining that the first block is in a key collision block state or a key collision extension block state;
identifying a third block based at least in part on the first block; and
deleting information about the third block from the first block.

Statement 175. An embodiment of the disclosure includes the system according to statement 174, wherein updating the first block further includes setting the third block to a free block state.

Statement 176. An embodiment of the disclosure includes the system according to statement 175, wherein setting the third block to the free block state includes setting the third block to the free block state by a state machine.

Statement 177. An embodiment of the disclosure includes the system according to statement 174, wherein updating the first block further includes setting the first block to a key block state or a free block state.

Statement 178. An embodiment of the disclosure includes the system according to statement 177, wherein setting the first block to the key block state or the free block state includes setting the first block to the key block state or the free block state by a state machine.

Statement 179. An embodiment of the disclosure includes the system according to statement 181, wherein updating the second block further includes setting the second block to a free block state.

Statement 180. An embodiment of the disclosure includes the system according to statement 179, wherein setting the second block to the free block state includes setting the second block to the free block state by a state machine (725).

Statement 181. An embodiment of the disclosure includes the system according to statement 161, wherein updating the second block includes deleting a value from the second block.

Statement 182. An embodiment of the disclosure includes the system according to statement 161, wherein updating the second block includes updating the second block based at least in part on a size of a value associated with the identifier.

Statement 183. An embodiment of the disclosure includes the system according to statement 182, wherein updating the second block based at least in part on the size of the value associated with the identifier includes updating a third block in the storage device.

Statement 184. An embodiment of the disclosure includes the system according to statement 183, wherein the second block and the third block are adjacent.

Statement 185. An embodiment of the disclosure includes the system according to statement 161, wherein the first block and the second block are adjacent.

Statement 186. An embodiment of the disclosure includes a system, comprising a non-transitory storage medium, the non-transitory storage medium having stored thereon instructions that, when executed by a machine, result in:
identifying a block in a storage device;
accessing a state of the block; and
setting an entry in the bitmap to reflect the state of the block.

Statement 187. An embodiment of the disclosure includes the system according to statement 186, the non-transitory storage medium having stored thereon further instructions that, when executed by the machine, result in repeating the operations of identifying the block, accessing the state of the block, and setting the entry in the bitmap for a second block in the storage device.

Statement 188. An embodiment of the disclosure includes the system according to statement 186, wherein setting the entry in the bitmap includes:
determining that the state of the block is a data collision meta block;
identifying a data collision block from the data collision meta block; and
mapping a first identifier of the data collision block to a second identifier of the data collision meta block.

Statement 189. An embodiment of the disclosure includes the system according to statement 188, wherein mapping a first identifier of the data collision block to a second identifier of the data collision meta block includes adding an entry to a mapping table to map the first identifier to the second identifier.

Statement 190. An embodiment of the disclosure includes a system, comprising a non-transitory storage medium, the non-transitory storage medium having stored thereon instructions that, when executed by a machine, result in:
receiving a request to access a key block on a storage device;
accessing a key from the key block on the storage device; and
prefetching a data from a value block on the storage device.

Statement 191. An embodiment of the disclosure includes the system according to statement 190, wherein prefetching the second data from the value block on the storage device includes identifying the value block from the key block.

Statement 192. An embodiment of the disclosure includes the system according to statement 191, wherein identifying the value block from the key block includes identifying the value block based at least in part on a data entry in the key block.

Statement 193. An embodiment of the disclosure includes the system according to statement 190, the non-transitory storage medium having stored thereon further instructions that, when executed by the machine, result in prefetching a second data from a second value block on the storage device.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

1. A system, comprising:
a queue, the queue including a request, the request including a first address;
a data structure storing an information associated with a second address; and
a submission component to determine whether to send the request to a storage device based at least in part on the first address and the second address associated with the information in the data structure being disjoint,
wherein the submission component includes a circuit, and
wherein the submission component is included in a host machine.

2. The system according to claim 1, further comprising a memory, the memory storing the queue and the data structure.

3. The system according to claim 1, wherein the data structure includes a radix tree.

4. The system according to claim 1, wherein the submission component is configured to delay sending the request to the storage device based at least in part on a partial overlap between the first address and the second address associated with the information in the data structure.

5. The system according to claim 1, further comprising a completion component to update the information in the data structure based at least in part on a completion message from the storage device, the completion component including a second circuit, the completion component included in the host machine.

6. The system according to claim 5, wherein:
the completion message is associated with the second address; and
the completion component is configured to remove the information from the data structure based at least in part on the completion message.

7. The system according to claim 5, wherein the completion component is configured to trigger the submission component based at least in part on the completion message and the queue containing the request.

8. A method, comprising:
accessing a request from a queue, the request including a first address;
accessing a data structure, the data structure including an information associated with a second address;
determining, by a submission component, that the first address and the second address associated with the information in the data structure are disjoint; and
sending the request to a storage device based at least in part on the first address and the second address associated with the information in the data structure being disjoint,
wherein the submission component includes a circuit; and
wherein the submission component is included in a host machine.

9. The method according to claim 8, further comprising:
determining that there is a partial overlap between the first address and the second address associated with the information in the data structure; and
delaying the sending of the request to the storage device based at least in part on the partial overlap between the first address and the second address associated with the information in the data structure.

10. The method according to claim 9, further comprising:
accessing a second request from the queue, the second request including a third address;
determining, by the submission component, that the third address and the second address associated with the information in the data structure are disjoint; and
sending the request to a storage device based at least in part on the third address and the second address associated with the information in the data structure being disjoint.

11. The method according to claim 8, further comprising:
accessing a second request from the queue, the second request including a third address;
determining, by the submission component, that the third address and the second address associated with the information in the data structure are disjoint; and
sending the request to a storage device based at least in part on the third address and the second address associated with the information in the data structure being disjoint.

12. The method according to claim 9, further comprising:
accessing a second request from the queue, the second request including a third address; and
delaying the sending of the second request to the storage device based at least in part on the partial overlap.

13. The method according to claim 8, further comprising:
accessing a second request from the queue, the second request including the first address; and
coalescing the request and the second request.

14. The method according to claim 8, further comprising:
receiving a completion message from the storage device; and
updating the data structure based at least in part on the completion message.

15. The method according to claim 14, wherein:
the completion message is associated with the second address; and
updating the data structure based at least in part on the completion message includes removing the information from the data structure based at least in part on the completion message.

16. The method according to claim 14, further comprising performing accessing the request from the queue, determining that the first address and the second address associated with the information in the data structure are disjoint, and sending the request to the storage device based at least in part on receiving the completion message.

17. The method according to claim 8, wherein:
the storage device includes a first region and a second region, the first region including the first address and the second address;
the data structure is associated with the first region; and
determining that the first address and the second address associated with the information in the data structure are disjoint includes determining that the first address and the second address associated with the information in the data structure are disjoint based at least in part on the first address being in the first region.

18. The method according to claim 17, wherein:
the second region includes a third address and a fourth address;
accessing a second request from a second queue, the request including the third address;
accessing a second data structure, the second data structure including a second information associated with the fourth address;
determining that the third address and the fourth address associated with the second information in the second data structure are disjoint; and
sending the second request to the storage device based at least in part on the third address and the fourth address associated with the second information in the data structure being disjoint.

19. A system, comprising a non-transitory storage medium, the non-transitory storage medium having stored thereon instructions that, when executed by a machine, result in:
accessing a request from a queue, the request including a first address;
accessing a data structure, the data structure including an information associated with a second address;
determining, by a submission component, that the first address and the second address associated with the information in the data structure are disjoint; and
sending the request to a storage device based at least in part on the first address and the second address associated with the information in the data structure being disjoint.
wherein the submission component includes a circuit; and
wherein the submission component is included in a host machine.

20. The system according to claim 19, further comprising:
determining that there is a partial overlap between the first address and the second address associated with the information in the data structure; and
delaying the sending of the request to the storage device based at least in part on the partial overlap between the first address and the second address associated with the information in the data structure.
